(19) United States
(12) Patent Application Publication
(10) Pub. No.: US 2026/0329223 A1
(43) Pub. Date: Oct. 22, 2026

(54) IMAGE FORMING APPARATUS

(71) Applicant: CANON KABUSHIKI KAISHA, Tokyo (JP)

(72) Inventors: SHUMA HIASA, Kanagawa (JP); TOMOYA TATEISHI, Kanagawa (JP)

(21) Appl. No.: 19/634,789

(22) Filed: Mar. 31, 2026

(30) Foreign Application Priority Data
Apr. 17, 2025 (JP) 2025-068391

(51) Int. Cl. G03G 21/16; G03G 15/01; G03G 15/08

(52) U.S. Cl. CPC G03G 21/1647; G03G 15/0173; G03G 15/0875; G03G 21/1633; G03G 2215/0177; G03G 2215/068; G03G 2221/163; G03G 2221/1654; G03G 2221/1657

(57) ABSTRACT

An image forming apparatus includes a rotary including a developing roller, and an accommodating frame provided with an accommodating portion and a receiving opening, a main body frame, an opening/closing member, a moving device configured to execute a moving operation. At least a portion of the toner cartridge is positioned outside the main body frame in a case where the toner cartridge is in the retracted position. The movement restricting portion is in the restricting state when the toner cartridge is positioned in the attachment position, and is configured to transition from the restricting state to the permitting state by a driving force of the drive source before the moving device moves the toner cartridge from the attachment position to the retracted position during the moving operation.

### BACKGROUND

### Field of the Technology

This disclosure relates to an image forming apparatus that forms an image on a recording material.

### Description of the Related Art

Japanese Patent Laid-Open No. 2007-183305 and Japanese Patent Laid-Open No. 2008-096852 describe an image forming apparatus equipped with a rotary provided with a plurality of developing rollers, and a plurality of toner cartridges each detachably attached to the respective rotary. The image forming apparatus described in Japanese Patent Laid-Open No. 2007-183305 allows the toner cartridges to be attached to and detached from the rotary by opening a cover of a printer apparatus body.

However, the image forming apparatus described in Japanese Patent Laid-Open No. 2007-183305 does not have a mechanism for locking the cover. In a case where the cover is not locked, a user may inadvertently open the cover even when there is no need to open the cover.

However, the issues to be resolved by the embodiments disclosed in this specification and drawings are not limited to the issue described above. Issues corresponding to the respective effects of each configuration illustrated in the embodiments described below may also be recognized as other issues.

### SUMMARY

According to a first aspect of the present disclosure, an image forming apparatus to which a toner cartridge provided with a discharge opening is detachably attached includes a rotary configured to rotate, the rotary including a developing roller, and an accommodating frame provided with an accommodating portion and a receiving opening, the accommodating portion being configured to accommodate toner to be supplied to the developing roller, the receiving opening being configured to communicate with the accommodating portion, a main body frame configured to accommodate the rotary and provided with a main body opening, an opening/closing member openably and closably supported with respect to the main body frame between a closed position in which the opening/closing member closes the main body opening and an open position in which the opening/closing member opens the main body opening, a moving device configured to execute a moving operation of moving the toner cartridge from an attachment position to a retracted position through the main body opening, a drive source configured to cause the moving device to execute the moving operation, and a movement restricting portion configured to transition between a restricting state in which movement of the opening/closing member from the closed position to the open position is restricted, and a permitting state in which the movement of the opening/closing member from the closed position to the open position is permitted. In a case where the toner cartridge is in the attachment position, the receiving opening and the discharge opening face each other. At least a portion of the toner cartridge is positioned outside the main body frame in a case where the toner cartridge is in the retracted position. The movement restricting portion is in the restricting state when the toner cartridge is positioned in the attachment position, and is configured to transition from the restricting state to the permitting state by a driving force of the drive source before the moving device moves the toner cartridge from the attachment position to the retracted position during the moving operation.

According to a second aspect of the present disclosure, an image forming apparatus to which a cartridge is detachably attached includes a main body frame provided with a main body opening, an opening/closing member openably and closably supported with respect to the main body frame between a closed position in which the opening/closing member closes the main body opening and an open position in which the opening/closing member opens the main body opening, a moving device configured to execute a moving operation of moving the cartridge from an attachment position to a retracted position through the main body opening, a drive source configured to cause the moving device to execute the moving operation, and a movement restricting portion configured to transition between a restricting state in which movement of the opening/closing member from the closed position to the open position is restricted, and a permitting state in which the movement of the opening/closing member from the closed position to the open position is permitted. The cartridge is accommodated in the main body frame in a case where the cartridge is in the attachment position. At least a portion of the cartridge is positioned outside the main body frame in a case where the cartridge is in the retracted position. The movement restricting portion is in the restricting state when the cartridge is positioned in the attachment position, and is configured to transition from the restricting state to the permitting state by a driving force of the drive source before the moving device moves the cartridge from the attachment position to the retracted position during the moving operation.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram illustrating an image forming apparatus according to a first embodiment.

FIG. 2 is a configuration diagram illustrating the image forming apparatus according to the first embodiment.

FIG. 3 is a schematic diagram illustrating a developing unit, a toner cartridge, and a tray according to the first embodiment.

FIG. 4A is a cross-sectional view illustrating the image forming apparatus according to the first embodiment.

FIG. 4B is a cross-sectional view illustrating the image forming apparatus according to the first embodiment.

FIG. 5 is a perspective view illustrating a rotary body according to the first embodiment.

FIG. 6A is a perspective view illustrating the image forming apparatus according to the first embodiment.

FIG. 6B is a perspective view illustrating the image forming apparatus according to the first embodiment.

FIG. 6C is a perspective view illustrating the image forming apparatus according to the first embodiment.

FIG. 7A is a cross-sectional view illustrating the image forming apparatus according to the first embodiment.

FIG. 7B is a cross-sectional view illustrating the image forming apparatus according to the first embodiment.

FIG. 8 is a diagram illustrating the rotary body according to the first embodiment.

FIG. 9 is a diagram illustrating the rotary body according to the first embodiment.

FIG. 10 is a diagram illustrating the rotary body according to the first embodiment.

FIG. 11A is a diagram illustrating a configuration relating to movement of the tray according to the first embodiment.

FIG. 11B is a diagram illustrating the configuration relating to the movement of the tray according to the first embodiment.

FIG. 12A is a diagram illustrating the configuration relating to the movement of the tray according to the first embodiment.

FIG. 12B is a diagram illustrating the configuration relating to the movement of the tray according to the first embodiment.

FIG. 13A is a diagram illustrating a door positioned in a closed position and the tray positioned in an accommodating position according to the first embodiment

FIG. 13B is a diagram illustrating the door positioned in the closed position and the tray positioned in the accommodating position according to the first embodiment

FIG. 13C is a diagram illustrating a state in which a drive rack according to the first embodiment moves upward from a non-engagement position.

FIG. 13D is a diagram illustrating the state in which the drive rack according to the first embodiment moves upward from the non-engagement position.

FIG. 14A is a diagram illustrating a state in which the drive rack according to the first embodiment moves further upward from the non-engagement position.

FIG. 14B is a diagram illustrating the state in which the drive rack according to the first embodiment moves further upward from the non-engagement position.

FIG. 14C is a diagram illustrating the tray positioned in a take-out position and the door positioned in an open position according to the first embodiment.

FIG. 14D is a diagram illustrating the tray positioned in the take-out position and the door positioned in the open position according to the first embodiment.

FIG. 15A is a diagram illustrating a door restriction member positioned in a restricting position according to a second embodiment.

FIG. 15B is a diagram illustrating the door restriction member positioned in the restricting position according to the second embodiment.

FIG. 15C is a diagram illustrating a state in which the door restriction member according to the second embodiment is pressed by the drive rack.

FIG. 15D is a diagram illustrating the state in which the door restriction member according to the second embodiment is pressed by the drive rack.

FIG. 16A is a diagram illustrating a state in which the drive rack according to the second embodiment moves further upward from the non-engagement position.

FIG. 16B is a diagram illustrating the state in which the drive rack according to the second embodiment moves further upward from the non-engagement position.

FIG. 16C is a diagram illustrating the tray positioned in the take-out position and the door positioned in the open position according to the second embodiment.

FIG. 16D is a diagram illustrating the tray positioned in the take-out position and the door positioned in the open position according to the second embodiment.

### DESCRIPTION OF THE EMBODIMENTS

Hereinafter, with reference to drawings, embodiments according to this disclosure will be described.

### First Embodiment

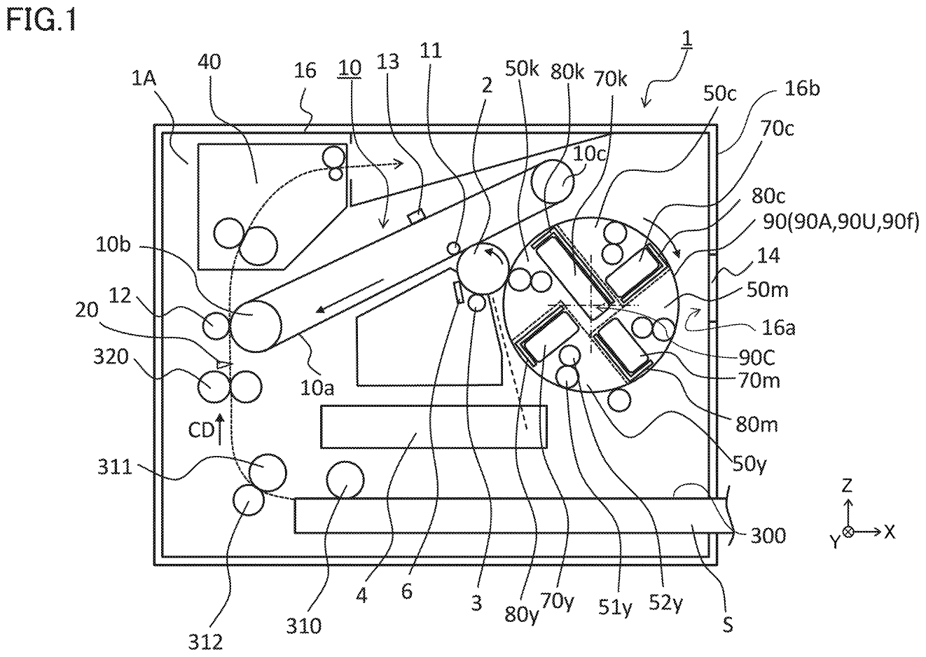

An image forming apparatus 1 according to the first embodiment will be described using FIGS. 1 to 12B. In the following description and drawings, a vertical direction in a case where the image forming apparatus 1 is installed on a horizontal plane is referred to as a Z direction. A direction intersecting with the Z direction and extending along a direction of a rotational axis 90C of a rotary body 90 described below (a rotational axis direction of a rotary) is referred to as a Y direction. To be noted, a direction of a rotational axis of a photosensitive drum 2 (a rotational axis direction of the photosensitive drum) is also parallel to the direction of the rotational axis 90C of the rotary body 90, and is the Y direction.

A direction intersecting with both the Z and Y directions is referred to as an X direction. The X and Y directions are preferably horizontal directions. In addition, the X, Y, and Z directions are preferably orthogonal to each other. In addition, as necessary, directions of arrows X, Y, and Z illustrated in the drawings are respectively referred to as a +X side, +Y side, and +Z side, and the opposite sides thereof are respectively referred to as a −X side, −Y side, and −Z side.

### Overall Configuration of Image Forming Apparatus

First, an overall configuration of the image forming apparatus 1 will be described. The image forming apparatus 1 is a laser beam printer that forms an image on a sheet S by an electrophotographic system. In more particular, the image forming apparatus 1 is a color laser beam printer provided with four developing units 50y, 50m, 50c, and 50k. As the sheet S, which is a recording material (recording medium), various sheet materials of different sizes and materials, including paper such as plain paper and thick paper, plastic films, cloth, sheet materials with surface treatment such as coated paper, and specially shaped sheet materials such as envelopes and index paper may be used.

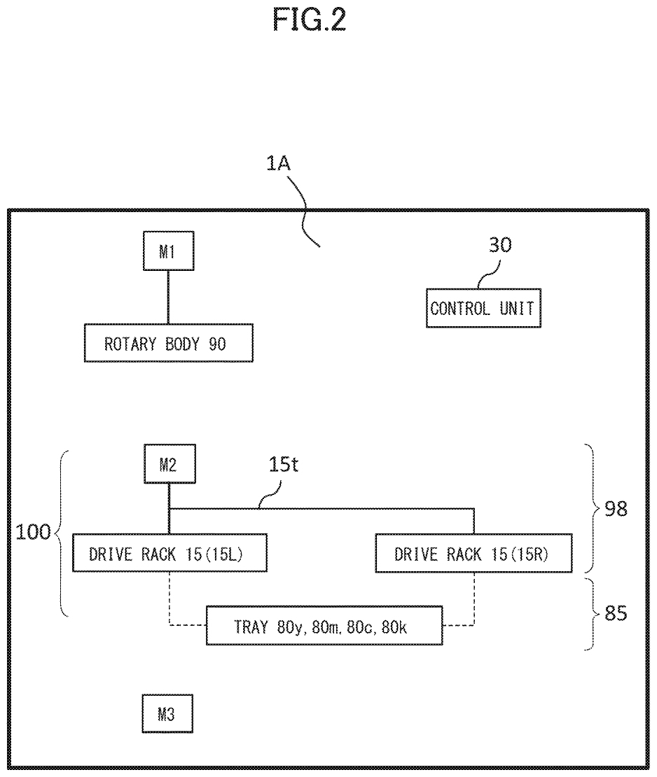

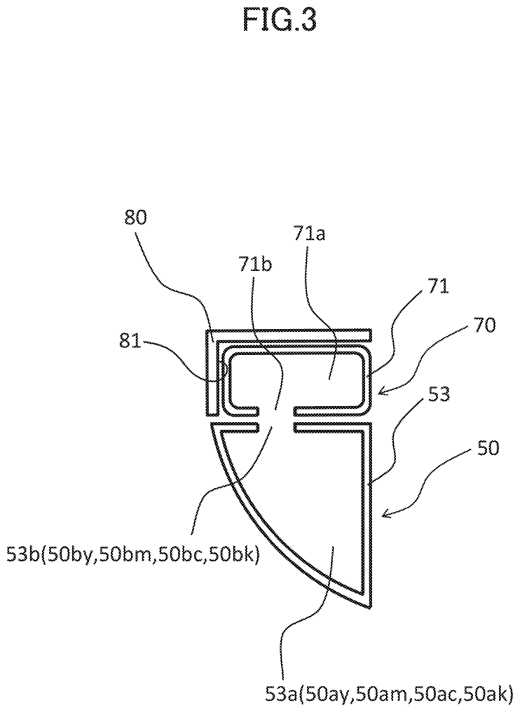

Using FIGS. 1, 2, and 3, a schematic configuration and an image formation operation of the image forming apparatus 1 will be described. FIG. 1 is a schematic diagram illustrating a cross-sectional configuration of the image forming apparatus 1. FIG. 2 is a diagram illustrating a drive source of the image forming apparatus 1. FIG. 3 is a conceptual diagram illustrating a configuration for supplying toner from a toner cartridge 70 to a developing unit 50.

As illustrated in FIG. 1, the image forming apparatus 1 includes an image forming apparatus body (hereinafter, referred to as “apparatus body”) 1A and toner cartridges 70y, 70m, 70c, and 70k detachably attachable to the apparatus body 1A. The apparatus body 1A of this embodiment is a portion of the image forming apparatus 1 excluding the toner cartridges 70y, 70m, 70c, and 70k.

The apparatus body 1A of the image forming apparatus 1 includes an electrophotographic photosensitive member (hereinafter, referred to as the photosensitive drum) 2, serving as an image bearing member that bears an electrostatic latent image, having a drum shape (cylindrical shape). A charge roller 3, a scanner 4, serving as an exposing device, and a cleaning unit 6 are disposed around the photosensitive drum 2.

The charge roller 3 is an example of a charging device or a charging unit for uniformly charging the photosensitive drum 2. The scanner 4 is an example of an exposing device that irradiates the photosensitive drum 2 with laser light corresponding to image information to perform exposure. By irradiating the charged photosensitive drum 2 with the laser light, the electrostatic latent image is formed on a surface of the photosensitive drum 2. The cleaning unit 6 is an example of a cleaning member that removes the toner remaining on the surface of the photosensitive drum 2.

Further, the apparatus body 1A includes a sheet storing portion 300, a pickup roller 310, a feed roller 311, a separation roller 312, a conveyance roller pair 320, a conveyance sensor 20, a secondary transfer roller 12, a fixing unit 40, and an intermediate transfer unit 10. The pickup roller 310 is an example of a sheet feed device or a sheet feed unit that feeds the sheet S. The feed roller 311 and the separation roller 312 are examples of a separation conveyance unit that conveys the sheets S while separating the sheet S into one sheet at a time by a frictional force. The secondary transfer roller 12 is an example of a transfer unit that transfers an image from an intermediate transfer belt 10a to the sheet S.

The intermediate transfer unit 10 includes the intermediate transfer belt 10a, a belt drive roller 10b, a tension roller 10c, a cleaning device 13, and a primary transfer roller 11. The intermediate transfer belt 10a is an example of an intermediate transfer member that bears the image transferred (primarily transferred) from the photosensitive drum 2 and conveys the image for transfer (secondary transfer) onto the sheet S. The intermediate transfer belt 10a is stretched around the belt drive roller 10b and the tension roller 10c. The belt drive roller 10b is a drive member that conveys the intermediate transfer belt 10a by being rotatably driven by a drive source.

In addition, the apparatus body 1A includes the rotary body (rotary, rotary member, developing device) 90 including developing units 50y, 50m, 50c, and 50k. As described below, in this embodiment, trays (support members) 80y, 80m, 80c, and 80k are attached to the rotary body 90. The toner cartridges 70y, 70m, 70c, and 70k are detachably attached to the trays 80y, 80m, 80c, and 80k.

In the following description, a plurality of members having similar functions may be distinguished by assigning numbers thereto. For example, one of the toner cartridges 70y, 70m, 70c, and 70k may be referred to as a first toner cartridge, one of the remaining three may be referred to as a second toner cartridge, one of the remaining two may be referred to as a third toner cartridge, and the last one may be referred to as a fourth toner cartridge. Similarly, one of the trays 80y, 80m, 80c, and 80k may be referred to as a first tray, one of the remaining three may be referred to as a second tray, one of the remaining two may be referred to as a third tray, and the last one may be referred to as a fourth tray. That is, one of the trays 80y to 80k is an example of a first support member, another one of the trays 80y to 80k is an example of a second support member, yet another one of the trays 80y to 80k is an example of a third support member, and the last one of the trays 80y to 80k is an example of a fourth support member. These numbering designations are used merely for convenience of description, and, in principle, may be interchanged as appropriate.

The developing units (first to fourth developing units) 50y, 50m, 50c, and 50k are examples of developing devices or developing portions that develop (visualize) the electrostatic latent images formed on the photosensitive drum 2 into toner images using the toner of corresponding colors. The developing units 50y, 50m, 50c, and 50k respectively develop the electrostatic latent images formed on the photosensitive drum 2 using a yellow toner, a magenta toner, a cyan toner, or a black toner. The developing units 50y, 50m, 50c, and 50k may be arranged in an order different from the order illustrated in FIG. 1.

The developing unit 50y includes a developing roller 51y, a supply roller 52y, and a developing blade. The developing roller 51y is a developer bearing member that bears the toner as developer, rotates, and supplies the toner to the photosensitive drum 2. The supply roller 52y is a supply member disposed in contact with the developing roller 51y, and supplies the toner to the developing roller 51y. The developing blade regulates the thickness of a toner layer borne on the developing roller 51y. The other developing units 50m, 50c, and 50k are provided with similar developing rollers 51m, 51c, and 51k, supply rollers, and developing blades.

The toner cartridges 70y, 70m, 70c, and 70k corresponding to the developing units 50y, 50m, 50c, and 50k are attached to the rotary body 90. The yellow toner, magenta toner, cyan toner, and black toner are respectively accommodated inside the toner cartridges 70y, 70m, 70c, and 70k as replenishment toner for the developing units 50y, 50m, 50c, and 50k. One of the four-color toners may be referred to as a first toner, one of the remaining three-color toners may be referred to as a second toner, one of the remaining two-color toners may be referred to as a third toner, and the last toner may be referred to as a fourth toner. For example, it can be said that the black toner is an example of the first toner and the magenta toner is an example of the second toner. These numbering designations are used merely for convenience of description, and, in principle, may be interchanged as appropriate.

Here, the rotary body 90 includes a rotary frame 90f that supports the developing units 50y, 50m, 50c, and 50k. The developing units 50y, 50m, 50c, and 50k are supported by the rotary frame 90f, which is a rotatable rotary support member.

In addition, the trays 80y, 80m, 80c, and 80k are attached to the rotary body 90. A combined portion of the rotary body 90 and the trays 80y, 80m, 80c, and 80k can be referred to as a rotary unit 90U. In other words, the rotary unit 90U includes the rotary body 90 and the trays 80y, 80m, 80c, and 80k.

The toner cartridges 70y to 70k are detachably held by the trays 80y to 80k. As described below, the trays 80y to 80k are supported so as to be slidably movable to the outside of the rotary body 90. A combined portion of the rotary unit 90U and the toner cartridges 70y, 70m, 70c, and 70k can be referred to as a rotary assembly 90A. In other words, the rotary assembly 90A includes the rotary unit 90U and the toner cartridges 70y, 70m, 70c, and 70k.

As described below, the rotary body 90 is rotatable around the rotational axis (rotation center) 90C. The rotational axis 90C corresponds to rotational axes of the rotary frame 90f, the rotary unit 90U, and the rotary assembly 90A. In addition, the rotational axis 90C is substantially parallel to the rotational axis (rotation center) of the photosensitive drum 2.

By rotating around the rotational axis 90C, the rotary body 90 can assume a developing posture in which any one of the developing rollers 51y, 51m, 51c, and 51k, serving as a plurality of developing rollers, faces the photosensitive drum 2. A posture in which the developing roller 51y faces the photosensitive drum 2 is referred to as a yellow developing posture. A posture in which the developing roller 51m faces the photosensitive drum 2 is referred to as a magenta developing posture. A posture in which the developing roller 51c faces the photosensitive drum 2 is referred to as a cyan developing posture. A posture in which the developing roller 51k faces the photosensitive drum 2 is referred to as a black developing posture. That is, the rotary body 90 can rotate around the rotational axis 90C so as to change the positions of the developing rollers 51y, 51m, 51c, and 51k with respect to the photosensitive drum 2. The black developing posture is an example of a first developing posture in which a first developing roller (developing roller 51k) faces the photosensitive drum 2. The other developing postures are examples of a second developing posture in which second developing rollers (developing rollers 51y to 51c) face the photosensitive drum 2. The yellow/magenta/cyan/black developing postures can also be referred to as first to fourth developing postures. These numbering designations are used merely for convenience of description, and, in principle, can be interchanged as appropriate.

As illustrated in FIG. 2, the apparatus body 1A includes motors M1, M2, and M3, serving as the drive sources. As described below, the motor M1, serving as a first motor, supplies a driving force for rotating the rotary body 90 around the rotational axis 90C. In other words, the motor M1 rotates the rotary assembly 90A and the rotary unit 90U around the rotational axis 90C.

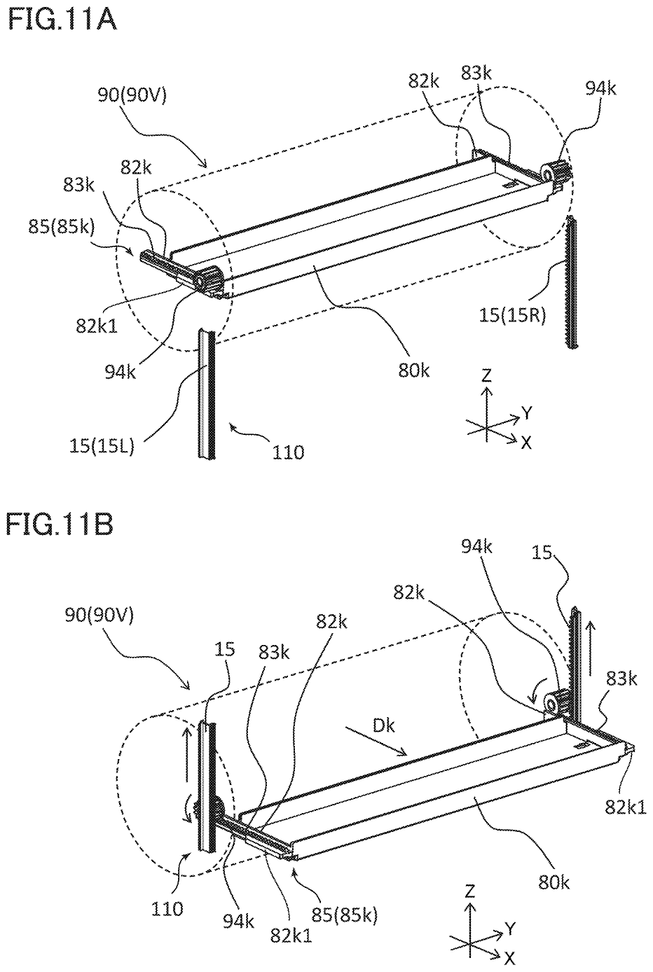

In addition, the apparatus body 1A includes a driving device 98 including the motor M2 and a transmission device 110 (refer to FIG. 11A). The transmission device 110 includes drive racks 15L and 15R, serving as drive gears, and a transmission portion 15t, described below. The transmission device 110 is an example of a transmission unit. A driving force of the motor M2, serving as a second motor, is transmitted to the drive racks 15L and 15R by the transmission portion 15t. In other words, the motor M2 is configured to drive the drive racks 15L and 15R, and moves the trays 80y, 80m, 80c, and 80k with respect to the rotary body 90 via the drive racks 15L and 15R.

The motor M3 drives members other than those driven by the motors M1 and M2. For example, the motor M3 drives the photosensitive drum 2, the developing units 50y, 50m, 50c, and 50k, the secondary transfer roller 12, the belt drive roller 10b, and the fixing unit 40.

To be noted, the members which are driven by the motors M1, M2, and M3 may be changed as appropriate. In addition, the functions of any two or all three of the motors M1, M2, and M3 may be integrated into a single motor. On the other hand, drive sources other than the motors M1, M2, and M3 may be added.

Further, the apparatus body 1A includes a control unit 30, serving as a control device for controlling the operation of the image forming apparatus 1. The control unit 30 includes a central processing unit (CPU) capable of executing programs, and a storage unit such as a read only memory (ROM) or a random access memory (RAM). The CPU reads out and executes programs stored in the storage unit to control an operation of actuators, such as the motors M1, M2, and M3, disposed in the image forming apparatus 1. The storage unit includes a non-volatile storage medium and a volatile storage medium, serves as a storage location for programs and data, and serves as a working space when the CPU executes programs. To be noted, each function of the control unit 30 described below may be implemented in circuits within the control unit 30 as independent hardware such as an application specific integrated circuit (ASIC).

Here, the suffixes y, m, c, and k appended to the developing units 50y, 50m, 50c, and 50k, the toner cartridges 70y, 70m, 70c, and 70k, the trays 80y, 80m, 80c, and 80k, and the like indicate the color of the toner. The basic configurations and functions of the developing units 50y, 50m, 50c, and 50k are substantially identical. The basic configuration and function of the toner cartridges 70y, 70m, 70c, and 70k are substantially identical. In addition, the basic configurations and functions of the trays 80y, 80m, 80c, and 80k are substantially identical. Accordingly, in a case where there is no need to distinguish each of them, the suffixes y, m, c, and k are omitted, and the description will refer to any one of the four units, cartridges, and trays. In addition, in a case of distinguishing each of the four units, cartridges, and trays, the suffixes y, m, c, and k are appended, and the description will refer to the one corresponding to the suffix among the four units, cartridges, and trays.

As illustrated in FIG. 3, the toner cartridge 70 includes a toner frame 71. The toner frame 71 includes a toner accommodating portion 71a for storing the toner, and a discharge opening 71b communicating with the toner accommodating portion 71a.

The developing unit 50 includes a developing frame (accommodating frame) 53 and is configured to attach the toner cartridge 70. The developing frame 53 includes a developing-side accommodating portion 53a (accommodating portion) and a receiving opening 53b communicating with the developing-side accommodating portion (toner supply chamber) 53a. That is, the rotary body 90 is provided with a developing frame 53y, a developing frame 53m, a developing frame 53c, and a developing frame 53k. In other words, the rotary body 90 is provided with a first developing chamber, a second developing chamber, a third developing chamber, and a fourth developing chamber. To be noted, as described above, while the developing unit 50 includes the developing roller 51, the supply roller 52, and the like, these members are omitted in FIG. 3.

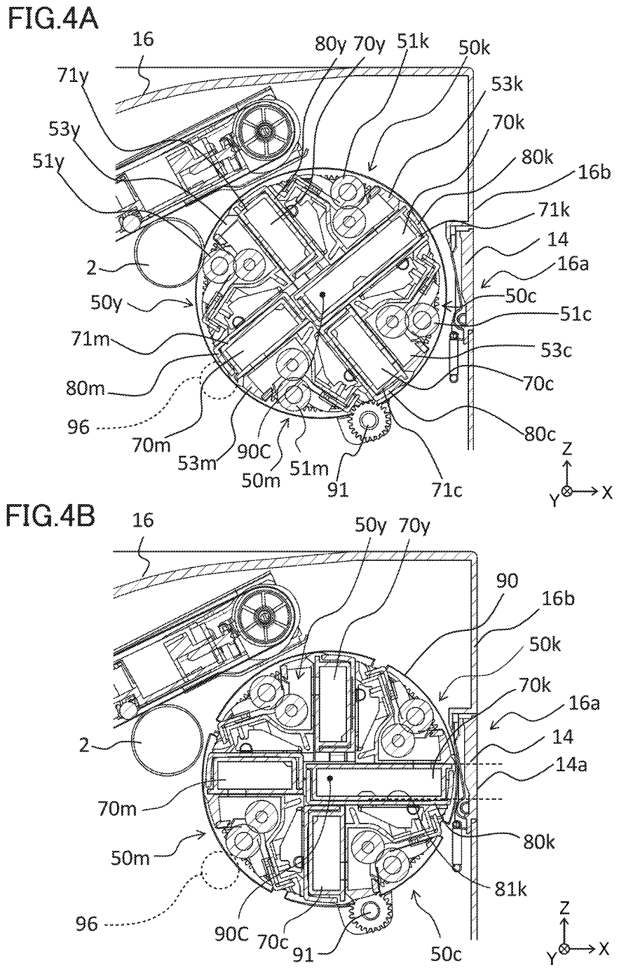

The developing roller 51k provided in the developing unit 50k is an example of the first developing roller. The developing roller 51m included in the developing unit 50m is an example of the second developing roller. The developing frame 53k (FIG. 4A) of the developing unit 50k provided with the developing-side accommodating portion 53a (first accommodating portion) is an example of a first accommodating frame provided with the first accommodating portion. The developing frame 53m (refer to FIG. 4A) of the developing unit 50m provided with the developing-side accommodating portion 53a (second accommodating portion) is an example of a second accommodating frame provided with the second accommodating portion. The rotary body 90 is an example of a rotatable rotary provided with the first and second developing rollers, the first accommodating frame provided with the first accommodating portion, and the second accommodating frame provided with the second accommodating portion. In this embodiment, the rotary body 90 includes the first to fourth developing rollers and the first to fourth accommodating frames.

As described below, with respect to the developing frame 53, the toner cartridge 70 is movable to an attachment position and to a retracted position retracted from the attachment position. In a state in which the toner cartridge 70 is in the attachment position with respect to the developing frame 53, the discharge opening 71b faces the receiving opening 53b. That is, the toner accommodating portion 71a of the toner cartridge 70 and the developing-side accommodating portion 53a of the developing unit 50 communicate with each other via the discharge opening 71b and the receiving opening 53b. When the toner is supplied from the toner cartridge 70 to the developing unit 50, at least a portion of the receiving opening 53b is positioned below at least a portion of the discharge opening 71b.

Then, the toner accommodated in the toner accommodating portion 71a is discharged from the discharge opening 71b, and the toner discharged from the discharge opening 71b is accommodated in the developing-side accommodating portion 53a through the receiving opening 53b. That is, a first developer is supplied to the first developing chamber included in the rotary body 90, a second developer is supplied to the second developing chamber, a third developer is supplied to the third developing chamber, and a fourth developer is supplied to the fourth developing chamber.

The toner accommodated in the developing-side accommodating portion 53a is supplied to the developing roller 51 by the supply roller 52. Through such a path, the toner accommodated in the toner accommodating portion 71a is supplied to the developing roller 51.

It is desirable that the toner cartridge 70 includes a sealing member (first sealing member), not shown, that covers the discharge opening 71b. In addition, it is desirable that the developing unit 50 includes a sealing member (second sealing member), not shown, that covers the receiving opening 53b.

In a state in which the toner cartridge 70 is not attached to the developing unit 50, it is preferable that the discharge opening 71b and the receiving opening 53b are respectively covered with the sealing members so as to suppress an outflow of the toner from the discharge opening 71b and the receiving opening 53b.

### Image Formation Operation

The image formation operation in this embodiment will be described. First, the photosensitive drum 2 is rotated in a direction of an arrow (counter-clockwise) in FIG. 1 in synchronization with the rotation of the intermediate transfer belt 10a. Then, the surface of the photosensitive drum 2 is uniformly charged by the charge roller 3.

In a case of forming a color image on the sheet S, as described below, the rotary body 90 rotates in a direction of an arrow (clockwise) in FIG. 1 while supporting the developing units 50y, 50m, 50c, and 50k. Then, the electrophotographic process is repeatedly performed while moving the developing rollers 51y, 51m, 51c, and 51k one at a time to a developing position.

First, the scanner 4 irradiates the laser light based on image data corresponding to a yellow image, and forms the electrostatic latent image corresponding to the yellow image on the surface of the photosensitive drum 2. In parallel with the formation of this electrostatic latent image, the motor M1 rotates the rotary body 90, and the rotary body 90 assumes the yellow developing posture. When the rotary body 90 assumes the yellow developing posture, the developing roller 51y is located in the developing position, and develops the electrostatic latent image formed on the photosensitive drum 2 with the yellow toner.

Here, in this embodiment, each of the developing rollers 51y, 51m, 51c, and 51k is an elastic roller including a metal shaft covered with rubber. In the developing position, each of the developing rollers 51y, 51m, 51c, and 51k develops the electrostatic latent image in a state of being in contact with the photosensitive drum 2. That is, the image forming apparatus 1 in this embodiment employs a contact development method. However, in the developing position, each of the developing rollers 51y, 51m, 51c, and 51k may develop the electrostatic latent image with a gap formed with respect to the photosensitive drum 2. That is, the image forming apparatus 1 may employ a non-contact development method.

When the toner image of yellow is developed, the toner image of yellow on the photosensitive drum 2 is primarily transferred onto the intermediate transfer belt 10a by the primary transfer roller 11 disposed on an inner side of the intermediate transfer belt 10a.

Thereafter, by rotating the rotary body 90 to sequentially move the developing rollers 51m, 51c, and 51k to the developing position, the toner images of each color are formed. In other words, after the toner image of yellow is formed on the intermediate transfer belt 10a, the rotary body 90 assumes the magenta developing posture, and the toner image of magenta is formed on the intermediate transfer belt 10a. After the magenta toner image is formed on the intermediate transfer belt 10a, the rotary body 90 assumes the cyan developing posture, and the toner image of cyan is formed on the intermediate transfer belt 10a. After the cyan toner image is formed on the intermediate transfer belt 10a, the rotary body 90 assumes the black developing posture, and the toner image of black (black color) is formed on the intermediate transfer belt 10a. That is, the developing rollers 51y, 51m, 51c, and 51k are capable of developing the electrostatic latent image into the toner image by using the toner of different colors from each other.

After the toner image of black is formed on the intermediate transfer belt 10a, the rotary body 90 rotates around the rotational axis 90C in the direction of the arrow (clockwise) illustrated in FIG. 1 to return to the yellow developing posture. To be noted, the color of the image initially formed on the intermediate transfer belt 10a is arbitrary, and for example, the black toner image may be formed first.

Then, by repeating the primary transfer so as to superimpose the toner images of four colors on the intermediate transfer belt 10a, the color image is formed on the intermediate transfer belt 10a. To be noted, the secondary transfer roller 12 and the cleaning device 13 do not come into contact with the intermediate transfer belt 10a until the color image is formed on the intermediate transfer belt 10a.

On the other hand, the sheet S is fed from the sheet storing portion 300 disposed at a lower part of the apparatus body 1A by the pickup roller 310. The sheet S is sent to the conveyance roller pair 320 in a state of being separated into one sheet at a time by the feed roller 311 and the separation roller 312. The conveyance roller pair 320 delivers the fed sheet S to a transfer portion (secondary transfer portion) which is a nip portion between the intermediate transfer belt 10a and the secondary transfer roller 12. In a sheet conveyance direction CD in which the sheet S is conveyed, the conveyance sensor 20 is disposed between the conveyance roller pair 320 and the secondary transfer roller 12, and the conveyance sensor 20, serving as a detection unit, is capable of detecting the sheet S. Timing at which the sheet S is delivered from the conveyance roller pair 320 to the secondary transfer portion is determined by timing at which a leading edge of the sheet S is detected by the conveyance sensor 20 and timing at which the color image is formed on the intermediate transfer belt 10a. The color image on the intermediate transfer belt 10a is transferred (secondarily transferred) onto a surface of the conveyed sheet S at the secondary transfer portion.

The sheet S onto which the color image has been transferred is sent to the fixing unit 40. In the fixing unit 40, the sheet S is processed by heating and pressurization; thereby, the image is fixed on the sheet S. The sheet S that has passed through the fixing unit 40 is discharged to the outside of the image forming apparatus 1 as a finished product.

On the other hand, in a case of forming a monochrome image on the sheet S, the rotary body 90 assumes the black developing posture. In this state, after the electrostatic latent image is formed on the surface of the photosensitive drum 2 by charging and exposing the photosensitive drum 2, the electrostatic latent image is developed with the black toner by the developing roller 51k positioned in the developing position. The toner image of black is primarily transferred onto the intermediate transfer belt 10a, and, thereafter, secondarily transferred onto the sheet S. The subsequent steps are the same as in the case of the color image.

### Rotary Configuration

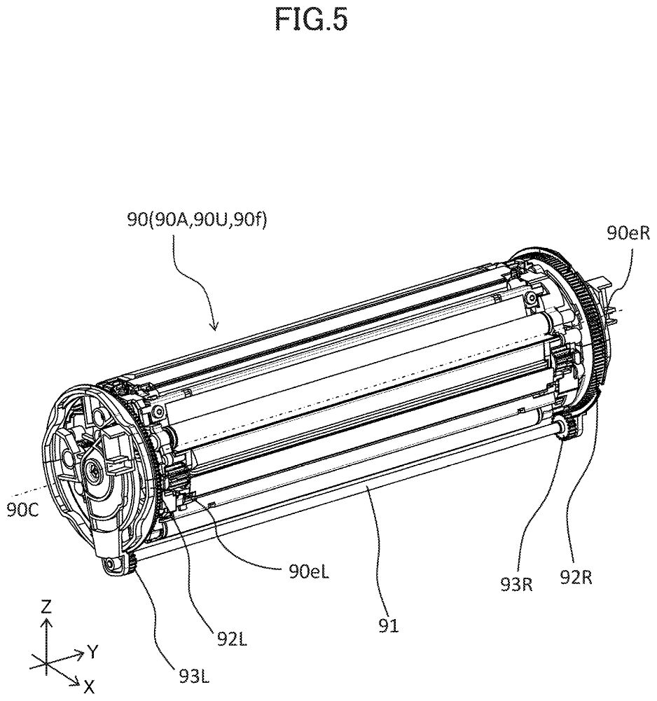

Using FIGS. 1, 4A, 4B, and 5, a configuration of the rotary body 90 will be described. FIGS. 4A and 4B are cross-sectional views illustrating the rotary body 90 of the image forming apparatus 1 and its adjacent components. To be noted, FIGS. 4A and 4B are the cross-sectional views taken along an imaginary plane perpendicular to the rotational axis 90C of the rotary body 90. FIG. 5 is a perspective view illustrating the rotary body 90.

As described above, the toner cartridges 70y to 70k are detachably attachable to the rotary body 90. In a case where the toner in the toner cartridges 70y to 70k is depleted, it is possible to replenish the toner to the image forming apparatus 1 by replacing the toner cartridges 70y to 70k.

As illustrated in FIG. 1, the apparatus body 1A includes a frame body 16 that accommodates the rotary body 90. The frame body 16 is a main body frame of the image forming apparatus 1 of this embodiment. The frame body 16 is a casing (building frame) of the apparatus body 1A constituted by frames and exterior members, and has a substantially rectangular parallelepiped shape in this embodiment.

The frame body 16 is provided with an opening (main body opening) 16a. In more particular, the frame body 16 is provided with a side surface 16b extending in a direction intersecting with the horizontal direction. The side surface 16b constitutes at least a portion of an exterior surface on the +X side of the apparatus body 1A. The opening 16a is disposed in this side surface 16b. The side surface 16b is a side surface disposed on a downstream side of a discharge port in a discharge direction in which the sheet S on which the image has been formed is discharged from the discharge port of the apparatus body 1A. From the side of the side surface 16b of the image forming apparatus 1, the user can replenish the sheet S by accessing the sheet accommodating portion 300, or obtain the sheet S discharged from the discharge port. Therefore, the side surface 16b can be referred to as a front surface (front face) of the apparatus body 1A.

The toner cartridges 70y, 70m, 70c, and 70k are detachably attachable to the rotary body 90 through the opening 16a. In other words, the toner cartridge 70k can be said to be an example of the first toner cartridge that accommodates the toner to be supplied to the first developing roller (developing roller 51k), and is detachably attachable to the rotary (rotary body 90) through the opening 16a of the frame body 16 of the apparatus body 1A. The toner cartridge 70m can be said to be an example of the second toner cartridge that accommodates the toner to be supplied to the second developing roller (developing roller 51m), and is detachably attachable to the rotary (rotary body 90) through the opening 16a of the frame body 16 of the apparatus body 1A.

In this embodiment, in a state of being supported by the trays 80y to 80k, the toner cartridges 70y, 70m, 70c, and 70k are attached to and detached from the rotary body 90 through the opening 16a. In other words, the user can attach and detach the toner cartridges 70y to 70k to and from the rotary body 90 via the trays 80y to 80k.

The opening 16a is disposed in the side surface 16b of the frame body 16. In this embodiment, the side surface 16b is a surface substantially parallel to the rotational axis 90C of the rotary body 90. Therefore, in a case where the replacement of the toner cartridge 70 is performed, the toner cartridge 70 passes through the opening 16a in a direction intersecting with the rotational axis 90C (preferably in a direction orthogonal thereto).

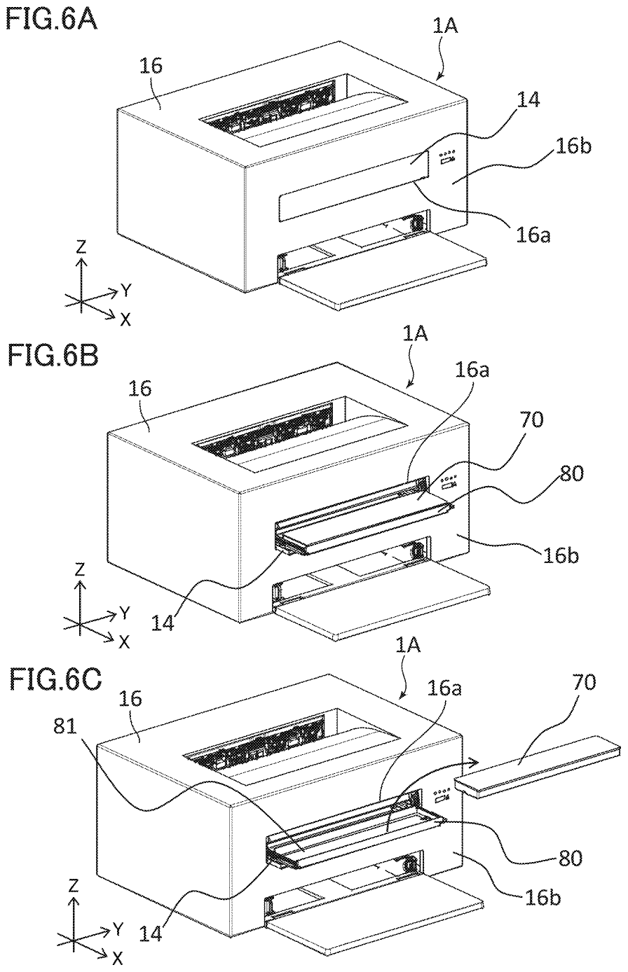

The image forming apparatus 1 includes a door 14 that covers the opening 16a of the frame body 16. The door 14 is an opening/closing member movable to a closed position (also refer to FIG. 6A) in which the opening 16a is covered, and to an open position (also refer to FIGS. 6B and 6C) in which the opening 16a is exposed. In other words, in the closed position, the door 14 closes the opening 16a, and, in the open position, opens the opening 16a.

As described above, in this embodiment, the toner cartridge 70 is configured to be detachably attached to the rotary body 90 via the tray 80. Therefore, the toner cartridge 70 can be stably attached to and detached from the rotary body 90.

In more particular, the user can replace the toner cartridge 70 by performing an operation of attaching and detaching the toner cartridge 70 to and from the tray 80, which is configured to move with respect to the rotary body 90 (that is, with respect to the apparatus body 1A). In a case of a configuration in which the user replaces the toner cartridge by directly inserting and detaching the toner cartridge with respect to the apparatus body, the user is required to insert the toner cartridge to a predetermined attachment position within the apparatus body. In this embodiment, in a state of supporting the toner cartridge 70, the tray 80 is movable so as to move the toner cartridge 70 to the attachment position. Therefore, the user can perform the replacement of the toner cartridge 70 by a simple operation of placing the toner cartridge 70 on the tray 80; thereby, operability is improved.

To be noted, the toner cartridge 70 is configured in an elongated shape extending in the Y direction, which is parallel to the rotational axis 90C of the rotary body 90, as a longitudinal direction. That is, a dimension of the toner cartridge 70 in the longitudinal direction is greater than the height and width of a cross section orthogonal to the longitudinal direction. In a case of handling such an elongated toner cartridge 70, by disposing the opening 16a in the side surface 16b, which extends substantially parallel to the longitudinal direction (Y direction) of the toner cartridge 70, of the frame body 16, the toner cartridge 70 can be passed through the opening 16a with a reduced moving distance. For example, compared to a case where the toner cartridge 70 is inserted into and detached through an opening disposed in a side surface on either one side (+Y side or −Y side) of the frame body 16 in the longitudinal direction of the toner cartridge 70, the replacement of the toner cartridge 70 becomes easier.

The rotary body 90 rotates around the rotational axis 90C, and can assume a replacement posture that permits the detachment of any one of the toner cartridges 70y to 70k from the rotary body 90. A posture that permits the detachment of the toner cartridge 70y is referred to as a yellow replacement posture. A posture that permits the detachment of the toner cartridge 70m is referred to as a magenta replacement posture. A posture that permits the detachment of the toner cartridge 70c is referred to as a cyan replacement posture.

A posture that permits the detachment of the toner cartridge 70k is referred to as a black replacement posture. The black replacement posture is an example of a first replacement posture that permits the detachment of the first toner cartridge from the rotary body 90. The yellow/magenta/cyan replacement postures are examples of a second replacement posture that permits the detachment of the second toner cartridge from the rotary body 90. The yellow/magenta/cyan/black replacement postures may also be referred to as the first through fourth replacement postures. These numbering designations are used merely for convenience of description, and, in principle, can be interchanged as appropriate.

The rotary body 90 rotates clockwise in FIG. 1 around the rotational axis 90C, and can sequentially assume the yellow/magenta/cyan/black replacement postures. In this embodiment, the rotary body 90 is alternately switched between the developing posture and the replacement posture by rotating clockwise in FIG. 1 around the rotational axis 90C. For example, in FIG. 1, the rotary body 90 assumes the black developing posture. From this state, by rotating the rotary body 90 clockwise, the posture of the rotary body 90 is switched in the following order: the cyan replacement posture, the yellow developing posture, the black replacement posture, the magenta developing posture, the yellow replacement posture, the cyan developing posture, and the magenta replacement posture. By rotating the rotary body 90 clockwise from the magenta replacement posture, the rotary body 90 returns to the black developing posture. That is, the rotary body 90 is capable of rotating clockwise for equal to or more than one full rotation (360°).

FIG. 4A illustrates a cross-section of the rotary body 90 in a state of assuming the developing posture (in particular, the yellow developing posture). FIG. 4B illustrates a cross-section of the rotary body 90 in a state of assuming the replacement posture (in particular, the black replacement posture).

As illustrated in FIGS. 4A and 4B, the four trays 80y to 80k are attached to the rotary body 90. The trays 80y to 80k respectively hold the toner cartridges 70y to 70k. In FIGS. 4A and 4B, the trays 80y to 80k are in a state of being accommodated inside the rotary body 90, and this state can be said to be a state in which the toner cartridges 70y to 70k are attached to the developing units 50y, 50m, 50c, and 50k.

As described above, with respect to the developing frame 53 of the developing unit 50, the toner cartridge 70 is movable to the attachment position and to the retracted position retracted from the attachment position. That is, with respect to the first accommodating frame (developing frame 53k), the first toner cartridge (toner cartridge 70k) is movable to a first attachment position and a first retracted position. With respect to the second accommodating frame (developing frame 53m), the second toner cartridge (toner cartridge 70m) is movable to a second attachment position and a second retracted position.

When located in the attachment position, the toner cartridge 70 is accommodated inside the frame body 16, and, when located in the retracted position, at least a portion of the toner cartridge 70 is positioned outside the frame body 16. As illustrated in FIG. 3, in a state in which the toner cartridge 70 is in the attachment position with respect to the developing frame 53, the discharge opening 71b and the receiving opening 53b face each other. In this state, the toner cartridge 70 is configured to supply the toner to the developing-side accommodating portion 53a through the receiving opening 53b (the opening of the accommodating frame).

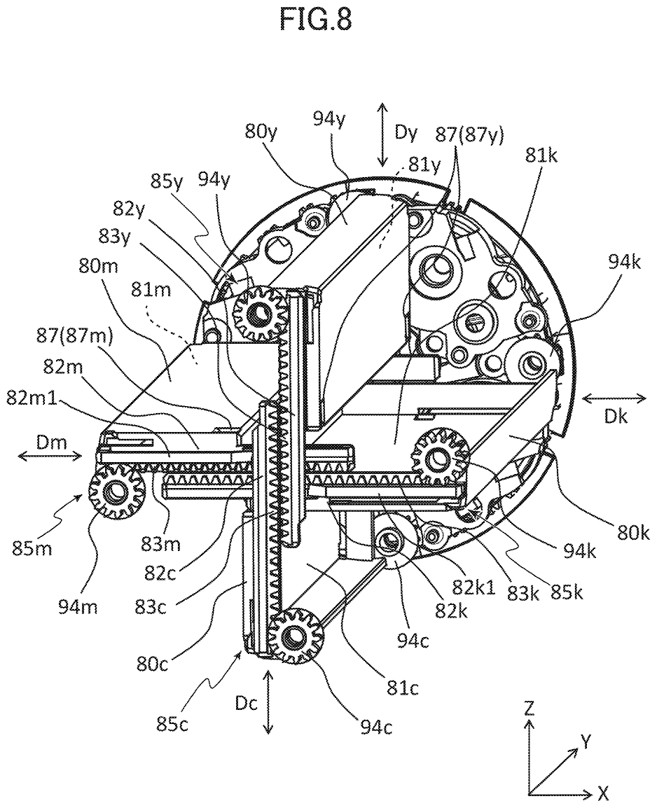

The apparatus body 1A includes a moving device 85 configured to move the toner cartridge 70 with respect to the rotary body 90 (in more particular, with respect to the developing frame 53 of the developing unit 50) from the attachment position to the retracted position. The moving device 85 will be described below using FIG. 8 and the like. In this embodiment, a plurality of moving devices 85y to 85k corresponding to the plurality of toner cartridges 70y to 70k are disposed in the rotary body 90. The trays 80y to 80k can be said to be a portion of these moving devices 85y to 85k.

In this embodiment, the toner cartridge 70k storing the black toner has a larger size than the toner cartridges 70y to 70c storing the yellow, magenta, and cyan toners, and can accommodate an increased amount of the toner. In other words, it can be said that the first toner cartridge is capable of storing a first quantity of toner, the second toner cartridge is capable of storing a second quantity of toner, and the first quantity is greater than the second quantity.

In particular, the length of the black toner cartridge 70k in a first radial direction with respect to the rotational axis 90C of the rotary body 90 is greater than the length of the magenta toner cartridge 70m in a second radial direction. Here, the first radial direction is a rotational radial direction of the rotary body 90 (a radial direction of an imaginary circle centered on the rotational axis 90C), and is a direction in which the toner cartridge 70k extends with respect to the rotational axis 90C when viewed in the direction of the rotational axis 90C. The second radial direction is a rotational radial direction of the rotary body 90, and is a direction in which the toner cartridge 70m extends with respect to the rotational axis 90C when viewed in the direction of the rotational axis 90C. Similarly, the length of the black toner cartridge 70k in the first radial direction is greater than the length of the toner cartridges 70y and 70c in radial directions corresponding to the other toner cartridges 70y and 70c.

Therefore, the tray 80k that holds the black toner cartridge 70k is larger in size than the trays 80y to 80c that hold the other toner cartridges 70y, 70m, and 70c. That is, the four toner cartridges 70y to 70k and the trays 80y to 80k, which have different sizes, are disposed within the rotary body 90. In other words, the toner cartridge 70k, serving as an example of the first toner cartridge, and the toner cartridge 70y, serving as an example of the second toner cartridge which is smaller in size than the first toner cartridge, are detachably attachable to the rotary body 90. Correspondingly, the rotary body 90 is provided with the tray 80k, serving as an example of the first support member that supports the first toner cartridge, and the tray 80y, serving as an example of the second support member that is smaller in size than the first support member. In addition, the toner cartridges 70m and 70c, serving as examples of the third toner cartridge and the fourth toner cartridge that are smaller in size than the first toner cartridge, are detachably attachable to the rotary body 90. Correspondingly, the rotary body 90 is provided with the trays 80m and 80c, serving as examples of the third support member and the fourth support member that are smaller in size than the first support member.

Here, using FIG. 5, the rotary drive of the rotary body 90 will be described. As illustrated in FIG. 5, disk gears 92L and 92R are formed at both end portions of the rotary body 90. In addition, rotary drive gears 93L and 93R are connected to both end portions of a swing shaft 91 in a drive-transmittable manner. Here, a driving force of the motor M1 is transmitted to the rotary drive gear 93R by a drive transmission mechanism. Next, the driving force is transmitted to the disk gears 92L and 92R by the rotary drive gears 93L and 93R; thereby, the rotary body 90 is rotatably driven. The rotary body 90 rotates clockwise in FIG. 1 around the rotational axis 90C.

In addition, the rotary body 90 is supported so as to be swingable around the swing shaft 91 as a center. The rotary body 90 is urged in a counter-clockwise direction in FIGS. 4A and 4B around the swing shaft 91 as a center by an urging member (not shown). This direction can be said to be a direction in which each of the developing rollers 51y to 51k approaches the photosensitive drum 2. As a result, in a state in which the rotary body 90 assumes the developing posture, each of the developing rollers 51y to 51k comes into contact with the photosensitive drum 2.

On the other hand, as illustrated in FIG. 5, rotary cams 90eL and 90eR are provided at both the end portions of the rotary body 90. When the rotary body 90 rotates clockwise in FIGS. 4A and 4B around the rotational axis 90C as a center, the rotary cams 90eL and 90eR come into contact with a roller 96 (FIGS. 4A and 4B) supported by the frame body 16. Then, the rotary body 90 moves in the clockwise direction in FIGS. 4A and 4B around the swing shaft 91 as a center. This direction can be said to be a direction in which each of the developing rollers 51y to 51k moves away from the photosensitive drum 2. In addition, this direction can be said to be a direction in which the rotary body 90 approaches the opening 16a of the frame body 16 and the door 14.

Thereby, when the rotary body 90 rotates and switches from the developing posture to the replacement posture, the rotary body 90 swings around the swing shaft 91 as a center. In a state in which the rotary body 90 assumes the replacement posture, the developing roller 51 is separated from the photosensitive drum 2.

As illustrated in FIG. 4B, in the black replacement posture, the toner cartridge 70k stops at a position facing the opening 16a, which is disposed in the side surface 16b of the apparatus body 1A, and the door 14. From this state, when the tray 80k is slidably moved from the attachment position onto the developing unit 50k to the outside of the rotary body 90, the user can replace the toner cartridge 70k.

### Replacement Operation of Toner Cartridge

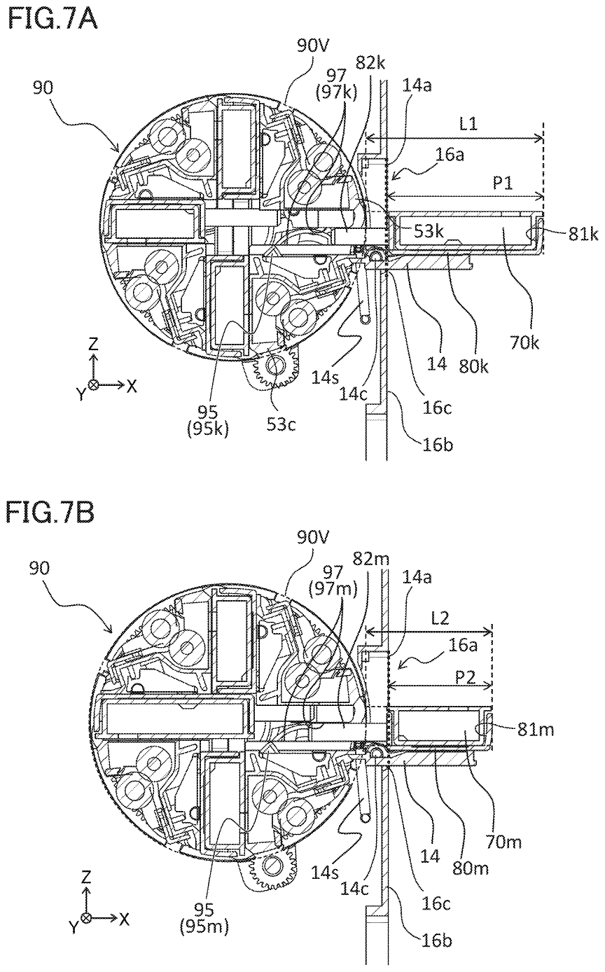

Using FIGS. 4A, 6A to 6C, and 7A and 7B, the toner cartridge replacement operation will be described. FIGS. 6A to 6C are external views illustrating the apparatus body 1A. FIGS. 7A and 7B are cross-sectional views illustrating an area surrounding the rotary body 90 during toner cartridge replacement. To be noted, FIGS. 7A and 7B are the cross-sectional views of the apparatus taken along an imaginary plane perpendicular to the rotational axis 90C of the rotary body 90.

FIG. 6A illustrates an external appearance of the apparatus body 1A during the image formation operation and in a standby state. The term “during the image formation operation” refers to a period during which a series of operations is being executed, from when the image forming apparatus 1 feeds the sheet S and forms the image on the sheet S until the sheet is discharged as the finished product. The term “standby state” refers to a state in which the image forming apparatus 1 is capable of initiating the image formation operation in a case of receiving an image formation instruction (print instruction), and is awaiting the image formation instruction from the user. As illustrated in FIG. 6A, during the image formation operation and in the standby state, the door 14 is held in a closed state.

FIG. 6B illustrates the external appearance of the apparatus body 1A during the toner cartridge replacement. During the toner cartridge replacement, the door 14 is placed in an open state, and the tray 80 and the toner cartridge 70 are moved to the exterior of the apparatus body 1A.

With respect to the developing frame 53 of the developing unit 50, the toner cartridge 70 is movable to the attachment position and to the retracted position retracted from the attachment position. In a state in which the toner cartridge 70 is in the attachment position with respect to the developing frame 53, as illustrated in FIG. 3, the discharge opening 71b and the receiving opening 53b face each other. As illustrated in FIGS. 4A and 4B, in the state in which the toner cartridge 70 is in the attachment position, the rotary body 90 is configured to rotate around the rotational axis 90C and assume the developing posture or the replacement posture.

The toner cartridge replacement operation will be described. First, the user instructs the control unit 30 (FIG. 2) of the apparatus body 1A to perform the toner cartridge replacement operation. The instruction for the toner cartridge replacement operation is performed, for example, by input via an operation panel (operation unit) disposed on the apparatus body 1A.

When the control unit 30 receives the instruction for the toner cartridge replacement operation, the rotary body 90 rotates to the replacement posture for the toner cartridge 70 to be replaced (the toner cartridge 70 that has been depleted of the toner) and stops. That is, the control unit 30 rotates the rotary body 90 to the replacement posture of the toner cartridge which has been designated in the instruction for the toner cartridge replacement operation (in FIG. 4B, the black replacement posture for replacing the black toner cartridge 70k). In the replacement posture, the tray 80, which supports the toner cartridge 70 for which the replacement has been instructed, faces the opening 16a of the frame body 16 of the apparatus body 1A.

For example, the rotary body 90 of FIG. 4A is located in the yellow developing posture in which the yellow developing roller 51y faces the photosensitive drum 2. At this time, the black toner cartridge 70k and the tray 80k are not required to face the opening 16a and the door 14. In other words, the toner cartridge 70 and the tray 80 are not required to face the opening 16a and the door 14 in a case where the rotary body 90 is in the replacement postures other than the replacement posture for the relevant toner cartridge or in the developing postures. Therefore, the opening 16a is only required to be sized to allow each toner cartridge 70 to pass through individually. When the rotary body 90 rotates clockwise in FIG. 4A by a predetermined angle from the yellow developing posture, the black toner cartridge 70k and the tray 80k face the opening 16a and the door 14, as illustrated in FIG. 4B.

Here, “the tray 80 faces the opening 16a” means that the tray 80 is positioned so as to be movable to the outside of the apparatus body 1A through the opening 16a. That is, in the case where the tray 80 faces the opening 16a, the relevant tray 80 is moved outward in the rotational radial direction of the rotary body 90 by a moving mechanism described below; thereby, the relevant tray 80 and the toner cartridge 70, which is supported by the relevant tray 80, can project to the outside of the apparatus body 1A. In FIG. 4A, any one of the trays 80y to 80k is not positioned to face the opening 16a. In FIG. 4B, only the black tray 80k faces the opening 16a, and the other trays 80y to 80c are not positioned to face the opening 16a.

When the rotary body 90 is positioned in the replacement posture, the tray 80, supporting the toner cartridge 70 to be replaced, is moved toward the outside of the apparatus body 1A by the motor M2.

Thereby, the toner cartridge 70 to be replaced moves from the attachment position to the retracted position with respect to the rotary body 90. In addition, as illustrated in FIGS. 6B, 6C, 7A, and 7B, the tray 80 and the toner cartridge 70 to be replaced, which is supported by the relevant tray 80, project to the outside of the apparatus body 1A through the opening 16a.

In more particular, with respect to the rotary body 90, the tray 80 is movable to an accommodating position and a take-out position. That is, with respect to the rotary body 90, the first tray is movable to an accommodating position and a take-out position. In addition, with respect to the rotary body 90, the second tray is movable to an accommodating position (third position) and a take-out position (fourth position). The accommodating position is a position in which the tray 80 is accommodated within the rotary body 90. The take-out position is a position (detachment position, replaceable position) in which at least a portion of the tray 80 projects (is exposed) outside the rotary body 90 and the toner cartridge 70 can be detached from the tray 80. Embodiments of the accommodating positions are positions of the respective trays 80y to 80k in FIGS. 4A and 4B. Embodiments of the take-out positions are positions of the tray 80 in FIGS. 6B and 6C, the tray 80k in FIG. 7A, and the tray 80m in FIG. 7B.

When the tray 80 is in the accommodating position, the toner cartridge 70 attached to the tray 80 is positioned inside the rotary body 90 and positioned in the attachment position. When the tray 80 is in the take-out position, the toner cartridge 70 attached to the tray 80 is positioned outside the rotary body 90 and positioned in the retracted position.

Here, as illustrated in FIGS. 7A and 7B, the rotary body 90 includes a projecting portion 95 for holding the toner cartridge 70 in the attachment position by holding the tray 80 in the accommodating position. As illustrated in FIG. 8, the tray 80 is provided with a recess portion 87 that are engaged with the projection portion 95. FIGS. 7A and 7B illustrate projecting portions 95k and 95m corresponding to the trays 80k and 80m, and FIG. 8 illustrates recess portions 87y and 87m of the trays 80y and 80m; however, the projecting and recess portions 95 and 87 are disposed for each of the trays 80y to 80k. It is preferable that the projecting portion 95 is urged in a direction of engagement with the recess portion 87.

When the projecting portion 95 engages with the recess portion 87 of the tray 80, the tray 80 is locked with respect to the rotary frame 90f. Thereby, even when the rotary body 90 rotates, the tray 80 remains in the accommodating position, and the toner cartridge 70 is prevented from being moved from the attachment position. To be noted, in a case where the tray 80 is moved between the accommodating position and the take-out position by the moving device described below, it is possible to configure such that the projecting portion 95 is moved by the tray 80, and the projecting portion 95 disengages from the recess portion 87.

In this embodiment, the door 14 is pivotably supported with respect to the apparatus body 1A. As illustrated in FIG. 7A, the door 14 is urged from the open position toward the closed position by a spring 14s. The spring 14s is, for example, a tension spring, and urges the door 14 so as to generate a moment in a counter-clockwise direction in FIGS. 7A and 7B around a support shaft 14c of the door 14 as a center.

When the tray 80 pushes the door 14, the door 14 transitions to the open state (the state of FIG. 6B). This state can also be said to be a state in which the tray 80 is supported by the door 14. By supporting at least a portion of the tray 80, which has projected outside the apparatus body 1A, by the door 14, the toner cartridge 70 can be supported more stably. In other words, when the first toner cartridge (toner cartridge 70k) is located in the first retracted position, the opening/closing member (door 14) located in the open position supports the first support member (tray 80k). In addition, when the second toner cartridge (toner cartridges 70y to 70c) is in the second retracted position, the opening/closing member (door 14) located in the open position supports the second support member (trays 80y to 80c).

In addition, in the open position, the door 14 is configured to come into contact with a portion of the frame body 16 of the apparatus body 1A (for example, a lower edge 16c of the opening 16a), and to be prevented from pivoting downward beyond the open position. When the tray 80 is pulled back from the outside to the inside of the apparatus body 1A, the door 14 returns to the closed position by an urging force of the spring 14s.

The toner cartridge 70 is detachably and attachably held in the tray 80. Therefore, as illustrated in FIG. 6C, the user can perform an operation (replacement operation) of detaching the toner cartridge 70 from the tray 80 and attaching a new toner cartridge 70. In a case of replacing the plurality of toner cartridges 70, the replacement operation can be performed by repeating the operation described above.

FIGS. 7A and 7B illustrate cross-sections around the rotary body 90 during the toner cartridge replacement. FIG. 7A illustrates a state during the replacement of the black toner cartridge 70k. FIG. 7B illustrates a state during the replacement of the magenta toner cartridge 70m.

The image forming apparatus 1 is provided with moving devices 85y, 85m, 85c, and 85k (FIG. 8) that respectively move the toner cartridges 70y, 70m, 70c, and 70k from the attachment position to the retracted position. When the suffixes are omitted and referred to as “moving device 85”, it ordinarily indicates any one of the moving devices 85y, 85m, 85c, and 85k. In this embodiment, the moving device 85 can be said to include the tray 80. The moving device 85k including the tray 80k can be said to be an example of a first moving device including the first support member. The moving device 85m including the tray 80m can be said to be an example of a second moving device including the second support member.

Even in a state in which the toner cartridge 70 is in the retracted position, the tray 80 remains in a coupled state with the rotary body 90 (in a state of being supported by the rotary body 90). In order to easily perform an operation of detaching the toner cartridge 70 from the rotary body 90, it is preferable that the length by which the toner cartridge 70 projects from the rotary body 90 in the retracted position is long. Since the toner cartridge 70 is configured to be detachably attached to the rotary body 90 via the tray 80, even in a case where the length by which the toner cartridge 70 projects from the rotary body 90 is long, the toner cartridge 70 can be stably supported by the tray 80.

A moving direction of the toner cartridge 70 when the toner cartridge 70 moves from the attachment position to the retracted position is referred to as a retraction direction. In this embodiment, the retraction direction of the toner cartridge 70 is a direction that intersects with the direction of the rotational axis 90C (Y direction). Therefore, as illustrated in FIGS. 7A and 7B, when viewed in the direction of the rotational axis 90C (Y direction), the retraction direction of the toner cartridge 70 is a direction orthogonal to the direction of the rotational axis 90C (Y direction). In addition, the retraction direction of the toner cartridge 70 can be said to be a direction toward the outside in the rotational radial direction of the rotary body 90 (a direction moving away from the rotational axis 90C).

As illustrated in FIGS. 7A and 7B, when detaching the toner cartridge 70, it is preferable that at least a portion of the toner cartridge 70 projects from the rotary body 90 to enable the user to perform a detachment operation of the toner cartridge 70 from the rotary body 90. In this embodiment, when the toner cartridge 70 is in the retracted position, the entirety of the toner cartridge 70 projects from the rotary body 90.

When the rotary body 90 rotates around the rotational axis 90C, a rotational trajectory of the rotary body 90 can be said to coincide with a circumscribed circle (virtual circle 90V indicated by a broken line in FIGS. 7A and 7B) of the rotary body 90 centered on the rotational axis 90C. When the toner cartridge 70 is in the retracted position, it is preferable that more than half of the length of the toner cartridge 70 in the retraction direction is located outside the rotational trajectory of the rotary body 90. That is, when viewed in the rotational axis direction of the rotary, in the state in which the toner cartridge is in the retracted position, with respect to the moving direction of the toner cartridge from the attachment position toward the retracted position, it is preferable that more than half of the entire length of the toner cartridge is positioned outside the rotational trajectory of the rotary. This applies to each toner cartridge 70, including the toner cartridge 70k as an example of the first cartridge and the toner cartridge 70m as an example of the second cartridge. In addition, in this embodiment, as illustrated in FIGS. 7A and 7B, when the toner cartridge 70 is in the retracted position, the entirety of the toner cartridge 70 is located outside the rotational trajectory (virtual circle 90V) of the rotary body 90.

Further, in order to facilitate the user in grasping the toner cartridge 70, when the toner cartridge 70 is in the retracted position, it is preferable that at least a portion of the toner cartridge 70 is located outside the image forming apparatus 1 (outside the apparatus body 1A). Here, “outside the apparatus” refers to a space external to the image forming apparatus 1 (external to the apparatus body 1A) when the image forming apparatus 1 is in use, such as during the image formation operation onto the sheet S.

In this embodiment, the exterior surface of the apparatus body 1A is formed by an exterior surface of the frame body 16. That is, the term “outside the apparatus” can also be said to be outside the frame body 16. Accordingly, the state in which at least a portion of the toner cartridge 70 is located outside the apparatus can also be said to be a state in which at least a portion of the toner cartridge 70 projects from the opening 16a of the frame body 16 of the apparatus body 1A toward the outside of the frame body 16.

In this embodiment, when the door 14 is in the closed position, the opening 16a of the frame body 16 of the apparatus body 1A is covered by the door 14. Then, an exterior surface 14a of the door 14 located in the closed position forms a portion of the exterior surface of the apparatus body 1A. In this case, the term “outside the apparatus” refers to the outside of the exterior surface 14a of the door 14 located in the closed position. That is, assuming that the position of the exterior surface 14a of the door 14 located in the closed position is referred to as an exterior position, when the toner cartridge 70 is in the retracted position, at least a portion of the toner cartridge 70 is positioned further outside the apparatus body 1A than the exterior position.

In other words, if the door 14 were in the closed position, at least a portion of the toner cartridge 70 is positioned in the space that would be outside the apparatus body 1A. In addition, with respect to the retraction direction of the toner cartridge 70, at least a portion of the toner cartridge 70 is positioned on a downstream side of the exterior position.

In addition, with the side surface 16b provided with the opening 16a being defined as the front face of the apparatus body 1A, when the toner cartridge 70 is in the retracted position, at least a portion of the toner cartridge 70 can be said to project toward the front face side further than the exterior surface on the front face side of the apparatus body 1A. In this case, the user can easily perform the replacement operation of the toner cartridge 70 by accessing the toner cartridge 70 from the front face side of the image forming apparatus.

To be noted, when the toner cartridge 70 is in the retracted position, it is preferable that more than half of the length of the toner cartridge 70 in the retraction direction is located outside the apparatus. That is, when viewed in the rotational axis direction of the rotary, in the state in which the toner cartridge is in the retracted position, it is preferable that more than half of the entire length of the toner cartridge with respect to the moving direction of the toner cartridge from the attachment position toward the retracted position is positioned outside the main body frame. This applies to each toner cartridge 70, including the toner cartridge 70k as an example of the first cartridge and the toner cartridge 70m as an example of the second cartridge. In addition, when the toner cartridge 70 is in the retracted position, it is more preferable that the entirety of the toner cartridge 70 is located outside the apparatus. To be noted, in this embodiment, the exterior surface 14a of the door 14 and the side surface 16b form the exterior surface on the front face side of the apparatus body 1A; however, the configuration of the door 14 is not limited to this. For example, the size of the door 14 may be configured to be a size that covers the entirety of the side surface 16b. In this case, the exterior surface 14a of the door 14 forms the exterior surface on the front face side of the apparatus body 1A.

The tray 80 is provided with a cartridge holding portion 81 (refer to FIGS. 3 and 6C) that holds the toner cartridge 70. The cartridge holding portion 81 is an attached portion to which the toner cartridge 70 is attached. When the tray 80 is in the take-out position, with respect to the retraction direction, it is preferable that the entirety of the cartridge holding portion 81 is located outside the rotational trajectory of the rotary body 90. When the tray 80 is in the take-out position, with respect to the retraction direction, it is preferable that at least half of the length of the cartridge holding portion 81 is located outside the apparatus.

Here, as described above, the toner cartridge 70k and the tray 80k are larger in size than the other toner cartridges 70y to 70c and the trays 80y to 80c. Therefore, as illustrated in FIGS. 7A and 7B, in this embodiment, a moving amount of the tray 80 during the toner cartridge replacement is varied in accordance with the size of the toner cartridge 70.

In particular, as illustrated in FIG. 7A, a moving distance when the tray 80k (first support member) moves from the accommodating position (first accommodating position) to the take-out position (first take-out position) is L1. A moving distance when the tray 80m (second support member) moves from the accommodating position (second accommodating position) to the take-out position (second take-out position) is L2. Although FIG. 7B illustrates a state in which the toner cartridge 70m and the tray 80m have moved, a moving distance when the trays 80y and 80c move from the accommodating position to the take-out position is also L2. At this time, L1 is greater than L2. In other words, it can be said that the moving distance of the first support member when the first toner cartridge moves from the first attachment position to the first retracted position is longer than the moving distance of the second support member when the second toner cartridge moves from the second attachment position to the second retracted position.

In addition, as illustrated in FIG. 7A, in a state in which the tray 80k is in the take-out position and the toner cartridge 70k is in the retracted position, the toner cartridge 70k projects outside the apparatus from the exterior surface of the apparatus body 1A by a distance P1. In this embodiment, the tray 80k also projects outside the apparatus from the exterior surface of the apparatus body 1A by the distance P1.

In addition, as illustrated in FIG. 7B, in a state in which the tray 80m is in the take-out position and the toner cartridge 70m is in the retracted position, the toner cartridge 70m projects outside the apparatus from the exterior surface of the apparatus body 1A by a distance P2. In this embodiment, the tray 80m also projects outside the apparatus from the exterior surface of the apparatus body 1A by the distance P2. The toner cartridges 70y and 70c also project outside the apparatus from the exterior surface of the apparatus body 1A by the distance P2.

The distance P1 described above is greater than the distance P2. That is, the length by which the first toner cartridge positioned in the first retracted position projects from the opening 16a of the apparatus body 1A is referred to as a first length (P1), and the length by which the second toner cartridge positioned in the second retracted position projects from the opening 16a is referred to as a second length (P2). In this case, the first length can be said to be longer than the second length.

For the toner cartridges 70y to 70c, which are smaller in size compared to the toner cartridge 70k, it is preferable from a structural strength standpoint that the distance P2 by which the toner cartridges 70y to 70c project outside the apparatus in the retracted position is configured to be shorter than the distance P1 by which the toner cartridge 70k projects outside the apparatus in the retracted position. This is due to the following reason. When the toner cartridge 70 is positioned in the retracted position, at least a portion of the toner cartridge 70 projects outside the rotational trajectory of the rotary body 90, or outside the apparatus, from the external surface of the apparatus body 1A. At this time, the tray 80 supports the weight of the toner cartridge 70 in a state of being cantilevered by the rotary body 90. Therefore, by reducing the distance P2 by which the toner cartridges 70y to 70c project outside the apparatus in the retracted position, it is possible to reduce the load applied to the trays 80y to 80c and the guide portions 97, which support the trays 80y to 80k, of the rotary body 90. In addition, since the toner cartridges 70y to 70c are smaller in size compared to the toner cartridge 70k, even if the distance P2 is configured to be shorter than the distance P1, the operability of the cartridge replacement with respect to the trays 80y to 80c can be maintained.

### Tray Arrangement within Rotary

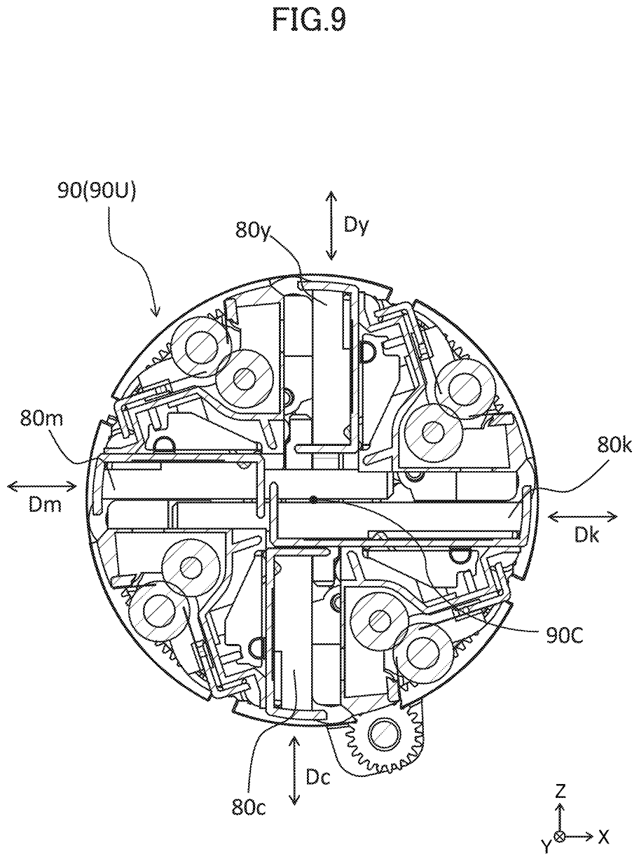

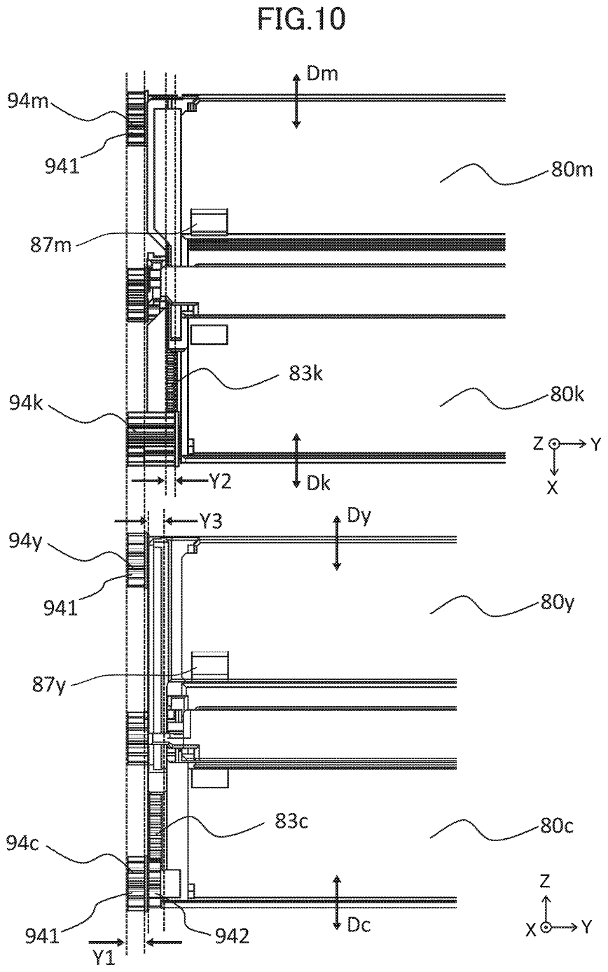

Using FIGS. 8, 9, and 10, the arrangement of the trays 80y to 80k within the rotary body 90 will be described. FIG. 8 is a perspective view illustrating the arrangement of the trays 80y to 80k within the rotary body 90. FIG. 9 is a cross-sectional view illustrating the arrangement of trays 80y to 80k within the rotary body 90. FIG. 10 is a diagram illustrating the arrangement of members on one end side in the Y direction of the trays 80y to 80k. To be noted, FIG. 9 illustrates a cross-section of the rotary body 90 taken along the imaginary plane perpendicular to the rotational axis 90C of the rotary body 90. In addition, an upper half portion of FIG. 10 is a diagram illustrating the rotary body 90 and the trays 80m and 80k of FIG. 8 as viewed from the upper side (+Z side) of FIG. 8, and a lower half portion of FIG. 10 is a diagram illustrating the rotary body 90 and the trays 80c and 80y of FIG. 8 as viewed from the right side (+X side) of FIG. 8.

As illustrated in FIG. 8, each of the trays 80y to 80k is provided with a cartridge holding portion 81y to 81k and a guided portion 82y to 82k. The toner cartridges 70y to 70k are respectively attached to the cartridge holding portions 81y to 81k. Each of the cartridge holding portions 81y to 81k accommodates at least a portion of the toner cartridges 70y to 70k attached thereto.

The guided portions 82y to 82k are disposed at both end portions of the trays 80y to 80k that sandwich the cartridge holding portions 81y to 81k in the Y direction. The guided portions 82y to 82k are each an elongated member extending in the direction perpendicular to the rotational axis of the rotary body 90.

In this embodiment, a reinforcing rib 82k1 is formed on a portion of the guided portion 82k in a moving direction Dk of the tray 80k, and a reinforcing rib 82m1 is formed on a portion of the guided portion 82m in a moving direction Dm of the tray 80m (also refer to FIGS. 11A and 11B). The reinforcing ribs 82k1 and 82m1 project outward in the Y direction from the guided portions 82k and 82m provided at both the end portions of the trays 80k and 80m in the Y direction, and have a rib shape (ridge) elongated in the moving directions Dk and Dm of the trays 80k and 80m. The reinforcing ribs 82k1 and 82m1 enhance the rigidity of the guided portions 82k and 82m.

To be noted, in this embodiment, the length of the reinforcing ribs 82m1 and 82k1 is limited so as to avoid the guided portions 82y and 82c; however, in a case where no interference with the guided portions 82y and 82c occurs, the reinforcing ribs 82m1 and 82k1 may be provided over the entire length of the guided portions 82m and 82k. Reinforcing ribs may be added to the guided portions 82y and 82c. In addition, in a case where the guided portions 82m and 82k have sufficient rigidity, a configuration may be adopted in which the reinforcing ribs 82m1 and 82k1 are not provided.

Rack portions 83y to 83k (rack gears) are formed on the guided portions 82y to 82k. In addition, within the rotary body 90, pinion gears 94y to 94k are rotatably held. The pinion gears 94y to 94k respectively engage with the rack portions 83y to 83k so as to be capable of transmitting drive.

The tray 80y is provided with equal to or more than one rack portion 83y. The rotary body 90 is provided with equal to or more than one pinion gear 94y corresponding to equal to or more than one rack portion 83y. Similarly, the trays 80m, 80c, and 80k are respectively provided with equal to or more than one rack portion 83m, equal to or more than one rack portion 83c, and equal to or more than one rack portion 83k. The rotary body 90 is provided with equal to or more than one pinion gear 94m, equal to or more than one pinion gear 94c, and equal to or more than one pinion gear 94k respectively corresponding to equal to or more than one rack portion 83m, equal to or more than one rack portion 83c, and equal to or more than one rack portion 83k.

The rack portions 83y to 83k and the trays 80y to 80k constitute a portion of the moving devices 85y to 85k configured to move the toner cartridges 70y to 70k from the attachment position to the retracted position. In addition, the rack portions 83y to 83k and the pinion gears 94y to 94k can be said to be a portion of driven devices that are driven by the driving device 98 of the apparatus body 1A. The pinion gears 94y to 94k can be said to be rotary members (rotating members) that move the trays 80y to 80k with respect to the rotary body 90 by rotating.

The moving devices 85y to 85k are driven by the driving device 98 of the apparatus body 1A. The pinion gears 94y to 94k and the rack portions 83y to 83k function as driven portions for the moving devices 85y to 85k of the rotary body 90 to receive a driving force from the driving device 98 of the apparatus body 1A. The rack portion 83k is an example of a first rack gear that constitutes at least a portion of a first driven portion provided in the first moving device. The rack portion 83m is an example of a second rack gear that constitutes at least a portion of a second driven portion provided in the second moving device.

The rotary body 90 includes the guide portions 97 (refer to FIGS. 7A and 7B) that engage with each of the guided portions 82y to 82k. FIG. 7A illustrates the guide portion 97 (97k) that engages with the guided portion 82k of the tray 80k, and FIG. 7B illustrates the guide portion 97 (97m) that engages with the guided portion 82m of the tray 80m. The rotary body 90 is provided with similar guide portions that engage with the guided portions 82y and 82c of the trays 80y and 80c. In addition, while FIGS. 7A and 7B illustrate the guide portions 97 provided on one side (+Y side) of the rotary body 90 in the Y direction, similar guide portions 97 are also provided on the other side (−Y side) of the rotary body 90 in the Y direction.

When the tray 80 moves between the accommodating position and the take-out position, the guide portion 97 maintains an engaged state with the guided portion 82 in at least a part of a movement range, and guides the tray 80 in the moving direction. In this embodiment, the guide portion 97 maintains the engaged state with the guided portion 82k throughout the entire movement range between the accommodating position and the take-out position of the tray 80k. In addition, in this embodiment, the guide portion 97 maintains the engaged state with the guided portion 82m throughout the entire movement range between the accommodating position and the take-out position of the tray 80m. In addition, as illustrated in FIGS. 8 and 9, within the rotary body 90, the four trays 80y to 80k are disposed so as to overlap with each other, as particularly described below.

When the pinion gears 94y to 94k rotate, the rack portions 83y to 83k and the trays 80y to 80k move with respect to the rotary body 90. As illustrated in FIG. 9, the four trays 80y to 80k are disposed with respect to the rotary body 90 such that the moving directions of the trays 80y to 80k are rotated by 90 degrees from each other. Therefore, the trays 80y and 80c, and the trays 80m and 80k are each held so as to be slidably movable in substantially the same direction (parallel direction). The moving direction of each of the trays 80y to 80k during such sliding movement is restricted by the engagement described above between the guided portions 82y to 82k and the guide portions 97.

To be noted, the trays 80y to 80k move outside the apparatus through the opening 16a. When each of the trays 80y to 80k moves outside the apparatus through the opening 16a, the moving direction of each tray is substantially the same direction (parallel).

As illustrated in FIG. 9, with respect to the moving direction Dk of the tray 80k, a range in which the tray 80k is disposed is arranged so as to overlap with a range in which the tray 80y is disposed and a range in which the tray 80c is disposed. In addition, with respect to the moving direction Dk of the tray 80k, the range in which the tray 80k is disposed overlaps with the rotational axis 90C of the rotary body 90. That is, it can be said that the toner cartridge 70k held by the cartridge holding portion 81k of the tray 80k overlaps with the rotational axis 90C of the rotary body 90 (FIG. 4B).

On the other hand, with respect to the moving direction Dm of the tray 80m, a range in which the tray 80m is disposed is arranged in an offset manner so as not to overlap with a range in which the tray 80y is disposed and with a range in which the tray 80c is disposed. In addition, with respect to the moving direction Dy of the tray 80y, a range in which the tray 80y is disposed is arranged in an offset manner so as not to overlap with a range in which the tray 80m is disposed and with a range in which the tray 80k is disposed. Similarly, with respect to the movement direction Dc of the tray 80c, a range in which the tray 80c is disposed is arranged in an offset manner so as not to overlap with a range in which the tray 80m is disposed and with a range in which the tray 80k is disposed.

Positional relationships among the trays 80 can also be described as follows. When viewed in the moving direction Dy of the tray 80y, the trays 80y and 80k overlap, but the trays 80y and 80m do not overlap. When viewed in the moving direction Dm of the tray 80m, the trays 80m and 80k overlap, but the tray 80m and the trays 80y and 80c do not overlap. When viewed in the moving direction Dc of the tray 80c, the trays 80c and 80k overlap, but the trays 80c and 80m do not overlap.

Here, when two elements (members, parts, units, etc.) overlap when viewed in a specific direction, it indicates that, in a case where each element is orthogonally projected onto a virtual plane perpendicular to the aforementioned specific direction, a projected region of one element and a projected region of the other element at least partially overlap.

As illustrated in FIGS. 8 and 10, with respect to the direction of the rotational axis 90C (Y direction), a range in which the rack portion 83m and the guided portion 82m are disposed and a range in which the rack portion 83k and the guided portion 82k are disposed at least partially overlap. That is, in this embodiment, with respect to the rotational axis direction of the rotary (Y direction), it can be said that the range in which the first rack gear (rack portion 83k) is disposed and the range in which the second rack gear (rack portion 83m) is disposed at least partially overlap. Therefore, compared to an arrangement in which the rack portion 83m and the guided portion 82m do not overlap with the rack portion 83k and the guided portion 82k, the rack portions 83m and 83k and the guided portions 82m and 82k can be disposed in a space-saving manner in the Y direction.

With respect to the direction of the rotational axis 90C (Y direction), the range in which the rack portion 83y and the guided portion 82y are disposed and the range in which the rack portion 83c and the guided portion 82c are disposed at least partially overlap. That is, in this embodiment, with respect to the rotational axis direction of the rotary (Y direction), the range in which the third rack gear (rack portion 83y) is disposed and the range in which the fourth rack gear (rack portion 83c) is disposed at least partially overlap. Therefore, compared to an arrangement in which the rack portion 83y and the guided portion 82y and the rack portion 83c and the guided portion 82c do not overlap, the rack portions 83y and 83c and the guided portions 82y and 82c can be arranged in a space-saving manner with respect to the Y direction.

Here, using FIG. 10, an engagement position between the rack portion (rack gear) 83 and the pinion gear 94 will be described. The upper half portion of FIG. 10 illustrates an engagement position of the rack portion 83k and the pinion gear 94k. The lower half portion of FIG. 10 illustrates an engagement position of the rack portion 83c and the pinion gear 94c.

With respect to the direction of the rotational axis 90C of the rotary body 90 (Y direction), in a region Y1 in FIG. 10, the driving force transmitted from the motor M2 (FIG. 2), serving as the drive source, via a transmission device described below is transmitted to the pinion gears 94y to 94k. With respect to the Y direction, in a region Y2 in FIG. 10, the pinion gear 94k engages with the rack portion 83k in a manner capable of transmitting drive. With respect to the Y direction, in a region Y3 in FIG. 10, the pinion gear 94c engages with the rack portion 83c in a manner capable of transmitting drive. To be noted, similar to the rack portion 83k, in the region Y2, the rack portion 83m engages with the pinion gear 94m (FIG. 8) in a manner capable of transmitting drive. Similar to the rack portion 83c, in the region Y3, the rack portion 83y engages with the pinion gear 94y (FIG. 8) in a manner capable of transmitting drive.

Here, the regions Y2 and Y3 are located in different positions in the Y direction (offset in the Y direction). In addition, the region Y1 is located in a different position in the Y direction from both the regions Y2 and Y3. In other words, the region Y1 is offset in the Y direction with respect to the regions Y2 and Y3.

Further, in a state in which the toner cartridges 70y and 70c are in the attachment position, with respect to the moving direction of the rack portion 83y (moving direction Dy of the tray 80y), the range in which the rack portion 83y is disposed and the range in which the rack portion 83c is disposed at least partially overlap. In this embodiment, since the moving directions Dy and Dc of the trays 80y and 80c are substantially the same direction (parallel), also with respect to the moving direction Dc of the tray 80c, the range in which the rack portion 83y is disposed and the range in which the rack portion 83c is disposed at least partially overlap. Therefore, in the state in which the toner cartridges 70y and 70c are in the attachment position, with respect to a direction orthogonal to the moving directions Dy and Dc of the rack portions 83y and 83c (left-right direction in FIG. 8), the respective tooth surfaces of the rack portions 83y and 83c oppose each other.

Further, in a state in which the toner cartridges 70m and 70k are in the attachment position, with respect to the moving direction of the rack portion 83m (the moving direction Dm of the tray 80m), the range in which the rack portion 83m is disposed and the range in which the rack portion 83k is disposed at least partially overlap. In this embodiment, since the moving directions Dm and Dk of the trays 80m and 80k are substantially the same direction (parallel), also with respect to the moving direction Dk of the tray 80k, the range in which the rack portion 83m is disposed and the range in which the rack portion 83k is disposed at least partially overlap. Therefore, in the state in which the toner cartridges 70m and 70k are in the attachment position, with respect to a direction orthogonal to the moving directions Dm and Dk of the rack portions 83m and 83k (the vertical direction in FIG. 8), the respective tooth surfaces of the rack portions 83m and 83k oppose each other.

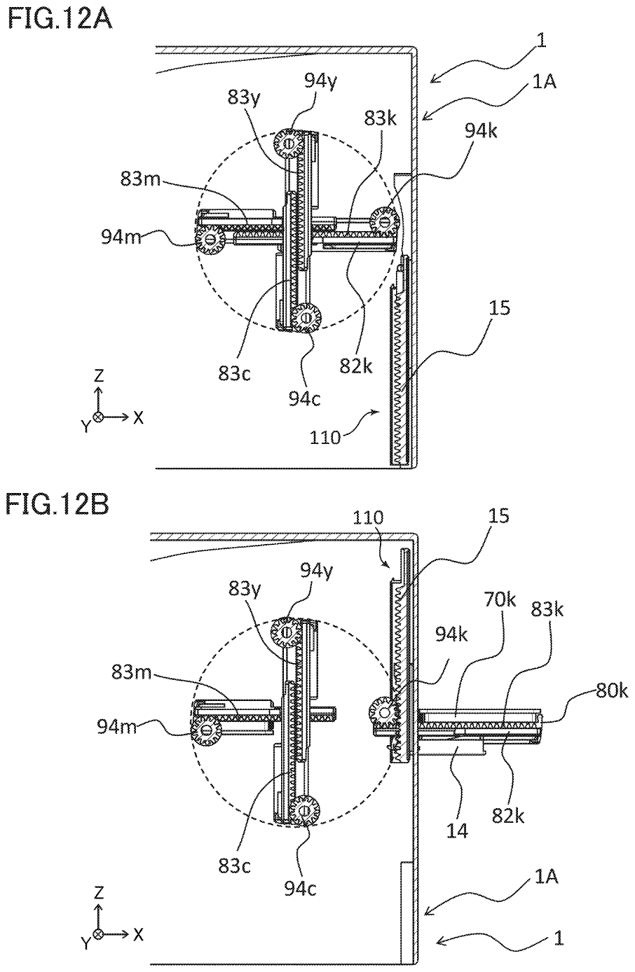

In addition, as illustrated in FIG. 12A described below, when viewed in the direction of the rotational axis 90C (Y direction), the rack portion 83y overlaps with the rack portions 83m and 83k. When viewed in the direction of rotational axis 90C (Y direction), the rack portion 83m overlaps with the rack portions 83y and 83c. When viewed in the direction of rotational axis 90C (Y direction), the rack portion 83c overlaps with the rack portions 83m and 83k. When viewed in the direction of rotational axis 90C (Y direction), the rack portion 83k overlaps with the rack portions 83y and 83c. In other words, it can be said that, with respect to the rotational axis direction (Y direction) of the rotary, the range in which the first rack gear (rack portion 83k) is disposed and the range in which the second rack gear (rack portion 83y) is disposed do not overlap. In addition, when viewed in the rotational axis direction (Y direction) of the rotary, in a state in which the first toner cartridge 70k is in the first attachment position and the second toner cartridge 70y is in the second attachment position, it can be said that the first rack gear (rack portion 83k) and the second rack gear (rack portion 83y) overlap.

In this manner, since, with respect to the Y direction, the positions in which the rack portions 83k and 83m are disposed differ from the positions in which the rack portions 83y and 83c are disposed, the rack portions 83y and 83c and the rack portions 83m and 83k can be disposed so as to overlap when viewed in the Y direction.

Thereby, it is possible to achieve the space-saving arrangement of the four trays within the rotary body 90, and is possible to realize the miniaturization of the rotary body 90 in the rotational radial direction. In other words, if, while maintaining the moving distance of each tray 80y to 80k equivalent to those of this embodiment, an attempt is made to arrange the rack portions 83 so as not to overlap when viewed in the Y direction, the area required for the arrangement of the four rack portions when viewed in the Y direction will be increased. Compared with such a configuration, by arranging the plurality of rack portions 83 with offset positions in the Y direction and overlapping the rack portions 83 when viewed in the Y direction, a disposition area of the rack portions 83 when viewed in the Y direction can be reduced.

In addition, in this embodiment, the four rack portions 83y to 83k are arranged in two sets of two each, with their positions offset in the Y direction. In other words, it can be said that, with respect to the rotational axis direction of the rotary (Y direction), the ranges in which the first and second rack gears are disposed overlap, and the ranges in which the third and fourth rack gears are disposed overlap. In addition, it can be said that, with respect to the Y direction, the range in which the first and second rack gears are disposed and the range in which the third and fourth rack gears are disposed are arranged so as not to overlap. Thereby, compared to a case where each of the four rack portions 83y to 83k is offset in positions in the Y direction, the miniaturization of the rotary body 90 in the Y direction is possible.

### Moving Configuration of Tray

Using FIGS. 11A, 11B, 12A and 12B, a configuration with respect to the movement of the trays 80y to 80k disposed within the rotary body 90 will be described. FIGS. 11A and 11B are perspective views illustrating a configuration relating to the movement of the tray 80k. FIGS. 12A and 12B are cross-sectional views illustrating the configuration relating to the movement of the tray 80k.

In this embodiment, the trays 80y to 80k are each driven by the driving force of the motor M2, which is transmitted to the pinion gears 94y to 94k via the driving racks 15L and 15R, serving as the transmission devices. Here, a configuration in which the tray 80k moves with respect to the rotary body 90 will be described, and, since configurations in which the trays 80y to 80c move with respect to the rotary body 90 are substantially similar to the configuration for the movement of the tray 80k, description thereof will be omitted.

FIG. 11A illustrates a state in which the tray 80k is positioned inside the rotary body 90 (that is, a state in which the toner cartridge 70k is attached to the developing unit 50k). In other words, FIG. 11A illustrates a state in which the tray 80k is in the accommodating position, which corresponds to a state in which the toner cartridge 70k is in the attachment position with respect to the developing frame 53k (FIG. 4A). FIG. 11B illustrates a state in which the tray 80k has been slidably moved to the outside of the rotary body 90. In other words, FIG. 11B illustrates a state in which the tray 80k is in the take-out position, which corresponds to a state in which the toner cartridge 70k is in the retracted position with respect to the developing frame 53k (FIG. 4A).

The apparatus body 1A of this embodiment includes the drive racks 15L and 15R, serving as the drive gears that drive the pinion gears 94. Each of the drive racks 15L and 15R is driven by the motor M2 via the transmission portion 15t. As illustrated in FIG. 11A, in a state in which the tray 80k is positioned inside the rotary body 90 (that is, in a state in which the toner cartridge 70k is attached to the developing unit 50k), the drive racks 15L and 15R are in the non-engagement position separated from the pinion gears 94k. The drive racks 15L and 15R engage with the pinion gears 94k by moving from the non-engagement position such that the tray 80k moves from the accommodating position to the take-out position and the toner cartridge 70k moves from the attachment position to the retracted position.

As described above, the two rack portions 83k are formed at both end portions of the tray 80k in the Y direction. Two each of the pinion gears 94k and the drive racks 15L and 15R are disposed at positions respectively corresponding to the rack portions 83k at both the end portions. That is, the apparatus body 1A of this embodiment includes the drive racks 15L and 15R, serving as a first drive gear and a second drive gear. It can be said that the drive rack 15L is an example of the first drive gear, and the drive rack 15R is an example of the second drive gear.

However, these numbering designations are used merely for convenience of description, and, in principle, can be interchanged as appropriate. When it is not necessary to distinguish between the drive racks 15L and 15R, they will be referred to as “drive rack 15”.

The rack portions 83 of this embodiment are configured as a rack gear pair, and the pinion gears 94 of this embodiment are configured as a pinion gear pair. While, in this embodiment, the rack and pinion gear pairs are disposed on one end side and the other end side of the support member (tray 80) in the Y direction, they may be disposed in other positions. The rack portions 83k and the pinion gears 94k corresponding to the tray 80k can be respectively said to be examples of a first rack gear pair and a first pinion gear pair.

It can be said that the rack portions 83y to 83c and the pinion gears 94y to 94c, which correspond to any of the other trays 80y to 80c, are respectively examples of a second rack gear pair and a second pinion gear pair.

One of the rack gear pair engages with one of the pinion gear pair, and the other of the rack gear pair engages with the other of the pinion gear pair. At least one of the pinion gear pair is driven by the drive rack 15L, serving as a first drive rack. In this embodiment, both pinion gears of the pinion gear pair are simultaneously driven by the drive racks 15L and 15R, serving as the first drive rack and a second drive rack. Thereby, the rotation of the tray 80 is less likely to occur, and the stable movement of the toner cartridge 70 becomes possible. To be noted, it may be configured such that the tray 80 includes one rack portion 83 and is moved by one drive rack 15 via one pinion gear 94.

The tray 80k is held so as to be slidably movable with respect to the rotary body 90 in a direction parallel to the guided portion 82k (i.e., moving direction Dk). The drive rack 15 is held so as to be slidably movable with respect to the apparatus body 1A in a direction intersecting with the moving direction Dk of the tray 80k. The drive rack 15 is configured to slidably move (reciprocally move) with respect to the apparatus body 1A in a first moving direction (upward in the vertical direction in this embodiment) and in a second moving direction (downward in the vertical direction in this embodiment) opposite to the first moving direction. That is, the moving direction of the drive rack 15 in this embodiment is a direction intersecting with (preferably orthogonal to) both the moving direction Dk of the tray 80k and the direction of the rotational axis 90C of the rotary body 90 (Y direction).

Using FIGS. 11A and 11B, a tray movement operation for slidably moving the tray 80k between the accommodating position and the take-out position will be described. The tray movement operation of the tray 80k is performed by the motor M2 (FIG. 2), the transmission portion 15t, the drive rack 15, the pinion gear 94k, and the rack portion 83k.

First, the tray movement operation (tray withdrawal operation) when detaching the toner cartridge 70k from the rotary body 90 will be described. In a state prior to commencing the tray withdrawal operation, the drive rack 15 is positioned below a position in which it engages with the pinion gear 94k (FIG. 11A). In addition, as described above, in the replacement operation of the toner cartridge 70k, the rotary body 90 assumes the replacement posture of the toner cartridge 70k (FIG. 4B).

When the tray withdrawal operation is commenced, the drive rack 15 is slidably moved in an upward direction of the apparatus body 1A by the driving force of the motor M2. During the movement of the drive rack 15, the drive rack 15 engages with the pinion gear 94k; thereby, the pinion gear 94k is rotatably driven.

As illustrated in FIG. 11B, when the pinion gear 94k is rotatably driven in a direction of an arrow in FIG. 11B, the driving force is input to the rack portion 83k that engages with the pinion gear 94k. Thereby, the tray 80k is pushed out of the apparatus and moves from the accommodating position to the take-out position with respect to the rotary body 90. The moving direction of the tray 80k at this time is guided in the predetermined moving direction Dk by engagement between the guided portion 82k and the guide portion 97k (FIG. 7A) of the rotary body 90. Due to the tray 80k moving from the accommodating position to the take-out position, the toner cartridge 70k is moved from the attachment position to the retracted position with respect to the developing unit 50k.

In a state in which the tray 80k is positioned in the take-out position and the toner cartridge 70k is positioned in the retracted position, the user can perform the attachment and the detachment of the toner cartridge 70k with respect to the tray 80k.

The tray movement operation (tray drawing operation, tray insertion operation) when attaching the toner cartridge 70 to the rotary body 90 is performed in a process that is reverse to the tray withdrawal operation. For example, when the user operates the predetermined operation unit, the tray drawing operation is initiated. When the tray drawing operation is initiated, the drive rack 15 is slidably moved in a downward direction of the apparatus body 1A by the driving force of the motor M2. Here, a rotational direction of the motor M2 in the tray drawing operation is opposite to that in the tray withdrawal operation.

By rotatably driving the pinion gear 94k in a direction opposite to the arrow in FIG. 11B, the driving force is input to the rack portion 83k that engages with the pinion gear 94k. Thereby, the tray 80k is drawn into the apparatus and moves with respect to the rotary body 90 from the take-out position to the accommodating position.

The moving direction of the tray 80k is guided in the moving direction Dk (the direction opposite to the arrow in FIG. 11B) by engagement between the guided portion 82k and the guide portion 97k (FIG. 7A) of the rotary body 90. As a result of the tray 80k moving from the take-out position to the storge position, the toner cartridge 70k is moved from the retracted position to the attachment position with respect to the developing unit 50k.

While the movement of the black tray 80k and the toner cartridge 70k is described above, the movement of the remaining trays 80y to 80c and the toner cartridges 70y to 70c is performed by a similar mechanism. In other words, in the replacement posture of each toner cartridge, the drive rack 15 transmits the driving force to the pinion gears 94y to 94c.

The driving device 98 for driving the moving device 85 provided in the rotary body 90 is constituted by the motor M2 disposed in the apparatus body 1A, and the transmission device 110, including the drive rack 15 (15L, 15R), the pinion gear 94, and the transmission portion 15t.

As described above, in this embodiment, the rotary body 90 is provided with the plurality of moving devices 85y to 85k corresponding to the plurality of toner cartridges 70y to 70k. The driving device 98 of the apparatus body 1A is a common driving device that drives the plurality of moving devices 85y to 85k (plurality of driven devices) of the rotary body 90.

In addition, in this embodiment, a drive target of the driving device 98 is switched by the rotation of the rotary body 90. In other words, the driving device of this embodiment includes the drive rack 15, serving as a transmission member for transmitting the driving force of the drive source. The driving device is capable of assuming a state in which the transmission member is engaged with the first driven portion (pinion gear 94k) in a manner enabling drive transmission, and a state in which the transmission member is engaged with the second driven portion (pinion gear 94m) in a manner enabling drive transmission. In addition, the driving device is capable of assuming a state in which the transmission member is disengaged from the first and second driven portions.

As described above, the pinion gears 94y to 94k are held by the rotary body 90. Therefore, when the rotary body 90 rotates, it is preferable that the engagement between the pinion gears 94y to 94k and the drive rack 15 is released.

FIG. 12A illustrates a state in which the tray 80k is positioned inside the rotary body 90 (a state of being positioned in the accommodating position). FIG. 12B illustrates a state in which the tray 80k has moved to the outside of the rotary body 90 (a state of having moved to the take-out position).

As illustrated in FIG. 12A, when the tray 80k is positioned inside the rotary body 90, the drive rack 15 is positioned in the lower portion within the apparatus body 1A. At this time, the drive rack 15 is retracted from the pinion gear 94k. Therefore, the drive rack 15 does not constitute an obstruction, and the rotary body 90 can be rotated. In more particular, the drive rack 15 can be retracted outside the rotational trajectory of the rotary body 90 indicated by a dotted line in FIGS. 12A and 12B.

As described above, by rotatably driving the motor M2 in forward and reverse directions, the tray 80 attached to the rotary body 90 can be moved with respect to the rotary body 90 from the accommodating position to the take-out position, and from the take-out position to the accommodating position. That is, the driving device of this embodiment not only drives each moving device of the rotary to cause the toner cartridge to move from the attachment position to the retracted position, but also can drive each moving device to cause the toner cartridge to move from the retracted position to the attachment position.

Here, as described above, in this embodiment, the moving amount of the tray 80 during the toner cartridge replacement is varied in accordance with the size of the toner cartridge 70. In particular, as illustrated in FIGS. 7A and 7B, the moving distance L1 when the black tray 80k moves from the accommodating position to the take-out position is longer than the moving distance L2 when the other trays 80y to 80c move from the accommodating position to the take-out position.

Therefore, in this embodiment, when moving the toner cartridges 70y to 70k from the attachment position to the retracted position, a value obtained by dividing the velocity of the rack portion 83k by the velocity of the drive rack 15 is greater than a value obtained by dividing the velocity of the rack portions 83y to 83c by the velocity of the drive rack 15.

For example, as illustrated in FIG. 10, the pinion gear 94y is configured as a stepped gear, and a pitch circle radius of a small-diameter gear 942 that engages with the rack portion 83y is reduced with respect to a pitch circle radius of a large-diameter gear 941 that engages with the drive rack 15. The pinion gears 94m and 94c are similarly configured as stepped gears. On the other hand, the pinion gear 94k is configured to have the same pitch circle radius in a portion that engages with the drive rack 15 and in a portion that engages with the rack portion 83k. At this time, the pitch circle radius of the pinion gear 94k can be configured to be the same as the pitch circle radius of the large-diameter gear 941 of the pinion gears 94y to 94c. According to this configuration, even if a moving distance of the drive rack 15 is the same, a moving distance of the rack portion 83k can be increased with respect to moving distances of the other rack portions 83y to 83c. That is, the moving distance L1 when the black tray 80k moves from the accommodating position to the take-out position can be made longer than the moving distance L2 when the other trays 80y to 80c move from the accommodating position to the take-out position.

In addition, by configuring the pinion gears 94y to 94c as the stepped gears, the moving distance L1 of the tray 80k can be increased with respect to the moving distance L2 of the other trays 80y to 80c, even though the pinion gears 94y to 94k are configured to receive the driving force from the same drive rack 15.

To be noted, instead of (or in combination with) the configuration in which the pinion gears 94y to 94c are the stepped gears, the pinion gear 94k may be configured as a stepped gear. In this case, a portion of the pinion gear 94k that engages with the drive rack 15 may be configured as a small-diameter gear, and a portion of the pinion gear 94k that engages with the rack portion 83k may be configured as a large-diameter gear having a pitch circle radius larger than that of the small-diameter gear. In addition, the stepped gear is one example of a deceleration mechanism, and may be replaced with known deceleration mechanisms that reduce a moving amount of a member on an output side (tray 80 side) with respect to a moving amount of a member on an input side (drive source side).

In addition, a moving amount of the drive rack 15 when moving the toner cartridge 70k from the attachment position to the retracted position may be increased with respect to a moving amount of the drive rack 15 when moving the toner cartridges 70y to 70c from the attachment position to the retracted position.

Incidentally, the shorter the distance that the toner cartridge 70 moves from the attachment position to the retracted position, the more the moving time of the toner cartridge 70 can be reduced, and the more the time the user waits for the movement of the toner cartridge 70 can be shortened. As described above, if the moving amount of the drive rack 15 with respect to the toner cartridge 70k is configured to be greater than the moving amount of the drive rack 15 with respect to the toner cartridges 70y to 70c, the time that the user waits for the movement of the toner cartridges 70y to 70c can be shortened.

With the configurations described above, the moving distance L1 can be made longer than the moving distance L2. These configurations can also be used in combination.

To be noted, while, in the configuration described above, the driven portion includes the pinion gear 94 that engages with both the drive rack 15 and the rack portion 83, the driven portion may include a gear that engages with the drive rack 15, and another gear that engages with the rack portion 83.

In addition, the configuration for moving the tray 80 is not limited to a so-called rack and pinion configuration. For example, a member corresponding to the pinion gear 94 may be replaced with a roller that rotates by receiving the drive of the motor M2, and the tray 80 may be moved by friction between the roller and the tray 80.

In addition, in a case of employing the roller that rotates by receiving the drive of the motor M2, the roller and the toner cartridge 70 may be brought into contact with each other. In this case, the toner cartridges 70y to 70k may be configured to be directly detachably attached to the rotary body 90 without the interposition of the trays 80y to 80k. In this case, the moving device 85 is constituted by the roller.

### Opening Restriction Mechanism of Door

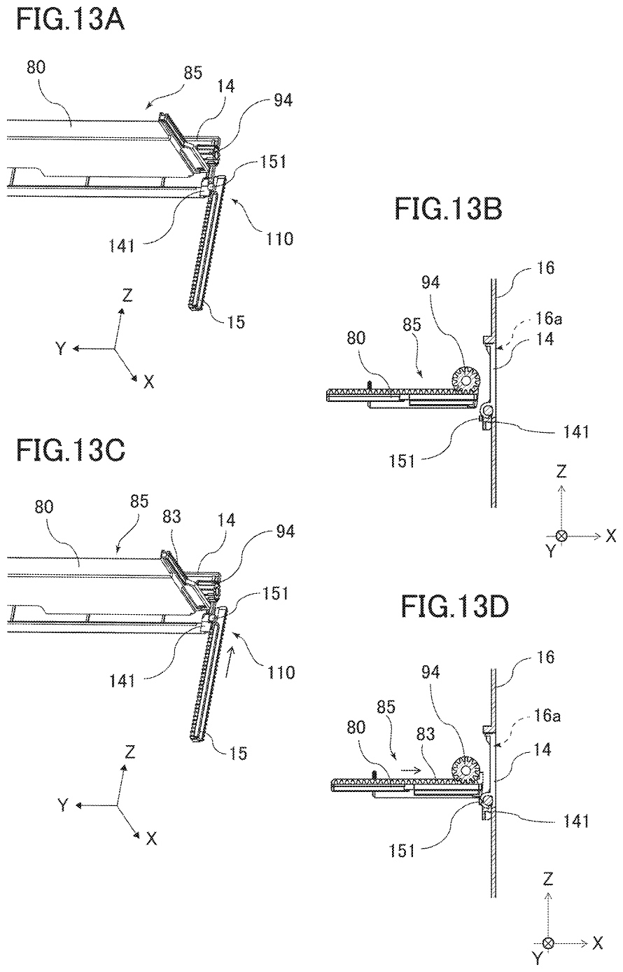

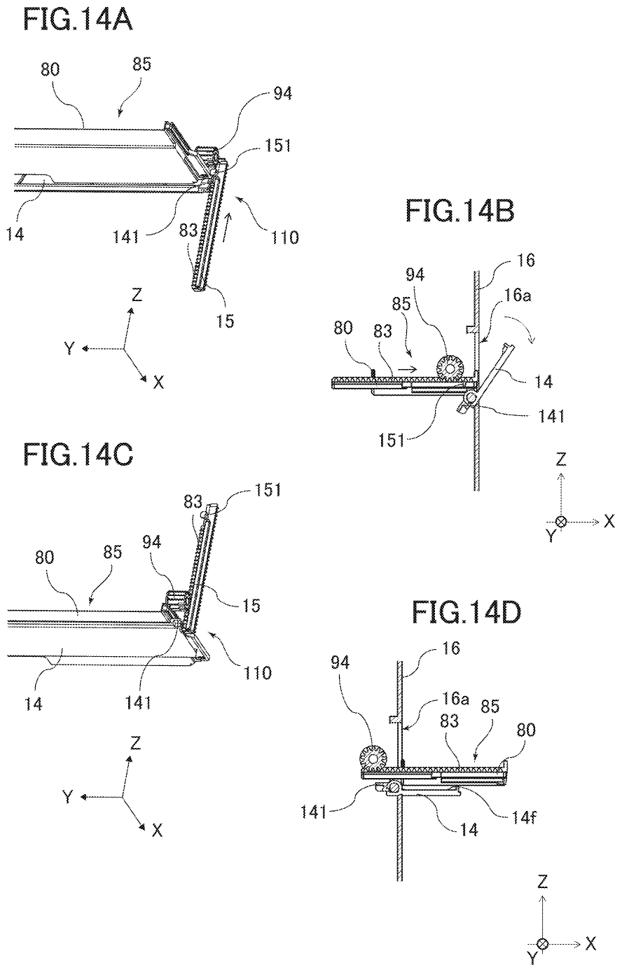

Next, using FIGS. 13A to 14D, a mechanism for restricting the movement of the door 14 from the closed position to the open position will be described. FIG. 13A is a perspective view illustrating the door 14 positioned in the closed position and the tray 80 positioned in the accommodating position, and FIG. 13B is a cross-sectional view illustrating the door 14 positioned in the closed position and the tray 80 positioned in the accommodating position. FIG. 13C is a perspective view illustrating a state in which the drive rack 15 moves upward from the non-engagement position, and FIG. 13D is a cross-sectional view illustrating the state in which the drive rack 15 moves upward from the non-engagement position. FIG. 14A is a perspective view illustrating a state in which the drive rack 15 moves further upward from the non-engagement position, and FIG. 14B is a cross-sectional view illustrating a state in which the door 14 is pressed toward the open position by the tray 80. FIG. 14C is a perspective view illustrating the tray 80 positioned in the take-out position, and FIG. 14D is a cross-sectional view illustrating the tray 80 positioned in the take-out position and the door 14 positioned in the open position. To be noted, in FIGS. 13A to 14D, the toner cartridge 70, which is supported by the tray 80, and the spring 14s, which urges the door 14, are not illustrated.

As described above using FIGS. 6A to 7B, the door 14 is pivotably supported with respect to the apparatus body 1A. The door 14 is urged from the open position toward the closed position by the spring 14s. For example, during the image formation and in the standby state, the door 14 is positioned in the closed position since it is urged by the spring 14s. On the other hand, during the replacement of the toner cartridge 70, the tray 80 pushes the door 14, and, thereby, the door 14 moves from the closed position to the open position. That is, except when replacing the toner cartridge 70, the door 14 is maintained in the closed position. To be noted, the door 14 may move from the closed position to the open position by the toner cartridge 70 pushing the door 14 when the toner cartridge 70 moves from the attachment position to the retracted position.

When the door 14 is in the closed position, as described above, the door 14 is urged from the open position toward the closed position by the spring 14s. However, if a moment acting on the door 14 by a force exerted by the user attempting to open the door 14 is greater than a moment exerted on the door 14 by the urging force of the spring 14s, the door 14 will be opened. For example, if the user touches the rotary body 90 during the image formation operation, the position of the developing roller 51 may be displaced with respect to the photosensitive drum 2, and there is a possibility that the uniformity of the toner image formed on the photosensitive drum 2 may be affected. In addition, when the door 14 is in the closed state, the possibility of foreign substances such as dust entering an interior of the frame body 16 is lower than when the door 14 is in the open state. Accordingly, it is desirable that the door 14 is always locked in the closed position except when replacing the toner cartridge 70.

As described above, the drive from the motor M2 is transmitted to the tray 80, which is a portion of the moving device 85, by the drive racks 15L and 15R and the pinion gear 94, which are at least part of the transmission device 110. Thereby, the tray 80 is movable between the accommodating position and the take-out position.

As illustrated in FIGS. 13A and 13B, in the case where the image forming apparatus 1 is performing the image formation or is in the standby state, the tray 80 is positioned in the accommodating position in which the tray 80 is accommodated in the rotary body 90. At this time, the door 14 is positioned in the closed position so as to close the opening 16a by the urging force of the spring 14s. In this embodiment, the drive rack 15 is provided with a door restricting portion 151 capable of coming into contact with a restricted portion 141 of the door 14. That is, the door restricting portion 151 is integrally formed with the drive rack 15, and moves in conjunction with the drive rack 15. The door restricting portion 151 is an example of a movement restricting portion. The drive rack 15 is a rack member capable of sliding movement. To be noted, the door restricting portion 151 may be disposed on only the drive rack 15R, on only the drive rack 15L, or on both the drive racks 15R and 15L, and, hereinafter, the drive racks 15R and 15L will be described as the drive rack 15 without distinction.

In a state in which the drive rack 15 is positioned in the non-engagement position, the tray 80 is positioned in the accommodating position, and the door 14 is positioned in the closed position, the door restricting portion 151 is disposed so as to oppose the restricted portion 141 of the door 14 in the X direction. The door restricting portion 151 is disposed so as to overlap with a moving trajectory when the door 14 moves from the closed position to the open position. In other words, the door restricting portion 151 is in a restricting state in which the door 14 is restricted from moving from the closed position to the open position. To be noted, at this time, the door restricting portion 151 may come into contact with the restricted portion 141 of the door 14, or may be disposed so as to oppose the restricted portion 141 with a gap therebetween.

That is, the door restricting portion 151 located in the restricting state is disposed so as to overlap with a moving trajectory of the restricted portion 141 when the door 14 moves from the closed position to the open position. In other words, the door restricting portion 151 located in the restricting state is positioned inside the moving trajectory of the restricted portion 141 when the door 14 moves from the closed position to the open position. Here, the moving trajectory of the restricted portion 141 refers to a space through which the restricted portion 141 passes when the door 14 moves from the closed position to the open position.

Therefore, even if the user attempts to open the door 14 from the closed position toward the open position, the restricted portion 141 of the door 14 abuts against the door restricting portion 151; thereby, the movement of the door 14 from the closed position to the open position is restricted. That is, in the case where the image forming apparatus 1 is performing the image formation or is in the standby state, the user can be prevented from inadvertently opening the door 14.

As illustrated in FIGS. 13C and 13D, when replacing the toner cartridge 70 (not shown) supported by the tray 80, the motor M2 (refer to FIG. 2), serving as the drive source, is driven. Then, the driving force of the motor M2 is transmitted to the drive rack 15 by the transmission portion 15t, and the drive rack 15 moves upward in the Z direction. As a result, the door restricting portion 151 of the drive rack 15 ceases to oppose the restricted portion 141 of the door 14 in the X direction, and becomes displaced from the restricted portion 141 in the Z direction. In other words, the door restricting portion 151 separates from the restricted portion 141. Thereby, the door restricting portion 151 transitions to a permitting state that permits the door 14 to move from the closed position to the open position, and the door 14 becomes movable from the closed position toward the open position. The door restricting portion 151 is configured to be moved by the driving force of the motor M2. Then, the door restricting portion 151 transitions from the restricting state to the permitting state by the driving force of the motor M2.

That is, the door restricting portion 151 in the permitting state is disposed so as not to overlap with the moving trajectory of the restricted portion 141 when the door 14 moves from the closed position to the open position. In other words, the door restricting portion 151 located in the permitting state is positioned outside the moving trajectory of the restricted portion 141 when the door 14 moves from the closed position to the open position.

At this time, the drive rack 15 is not yet engaged with the pinion gear 94, and the tray 80 has not moved from the accommodating position. Therefore, the tray 80 is not in contact with the door 14. That is, before the tray 80 moves from the accommodating position to the take-out position, the door restricting portion 151 transitions from the restricting state to the permitting state. In other words, before the toner cartridge 70 supported by the tray 80 moves from the attachment position to the retracted position, the door restricting portion 151 transitions from the restricting state to the permitting state.

The drive rack (rack gear) 15 is an example of a first gear and gear driven by the motor M2. In addition, the pinion gear 94 is an example of a second gear that is driven by the drive rack 15. As described above, the drive rack 15 is moved by the motor M2. The drive rack 15 is movable between the engagement position, in which the drive rack 15 engages with the pinion gear 94, and a separation position, in which the drive rack 15 is separated from the pinion gear 94. The non-engagement position of the drive rack 15 is an example of the separation position. When the image formation operation is performed on the sheet S or when the rotary body 90 rotates, the drive rack 15 is positioned in the separation position. When the moving operation of moving the toner cartridge 70 from the attachment position to the retracted position is performed, the drive rack 15 moves from the separation position to the engagement position. The door restricting portion 151 transitions from the restricting state to the permitting state before the drive rack 15 moves from the separation position to the engagement position. That is, the door restricting portion 151 transitions from the restricting state to the permitting state before the engagement of the drive rack 15 and the pinion gear 94 is initiated.

Then, as illustrated in FIGS. 14A and 14B, when the drive rack 15 moves further upward in the Z direction, the pinion gear 94 is rotated by the drive rack 15. Since the rack portion 83 of the tray 80 is engaged with the pinion gear 94, the tray 80 is moved in the X direction from the accommodating position toward the take-out position when the pinion gear 94 rotates. When the door 14 is pressed by the tray 80, the door 14 pivots from the closed position toward the open position while resisting the urging force of the spring 14s.

As illustrated in FIGS. 14C and 14D, in a state in which the tray 80 is positioned in the take-out position, the door 14 is positioned in the open position. At this time, a supporting portion 14f of the door 14 supports the tray 80 positioned in the take-out position from below. Thereby, since the tray 80 is stably held in the take-out position, operability can be improved when the attachment and the detachment of the toner cartridge 70 (not shown) with respect to the tray 80 is performed.

When the tray 80 moves from the take-out position to the accommodating position after the toner cartridge 70 has been replaced, the drive rack 15 moves downward in the-Z direction, and returns to the non-engagement position. Therefore, the door restricting portion 151 of the drive rack 15 again opposes the restricted portion 141 of the door 14 as illustrated in FIG. 13B, and transitions to the restricting state.

As described above, in this embodiment, the door restricting portion 151 is disposed on the drive rack 15 that constitutes a portion of the transmission device 110 (refer to FIGS. 11A and 11B). Then, the moving device 85 is capable of executing the moving operation of moving the toner cartridge 70 from the attachment position to the retracted position by the driving force of the motor M2 transmitted by the transmission device 110. When the toner cartridge 70 is positioned in the attachment position, the door restricting portion 151 is in the restricting state that restricts the movement of the door 14 from the closed position to the open position. Therefore, in the case where the image forming apparatus 1 is performing the image formation or is in the standby state, it is possible to prevent the user from inadvertently opening the door 14.

In addition, in the moving operation of the moving device 85, before the toner cartridge 70 moves from the attachment position to the retracted position, the door restricting portion 151 transitions from the restricting state to the permitting state. Therefore, when the tray 80 supporting the toner cartridge 70 presses the door 14 by the moving operation of the moving device 85, the door restricting portion 151 is in the permitting state, and the movement of the door 14 to the open position is not obstructed. Therefore, it is possible to suppress damage to the door 14 and the tray 80.

### Second Embodiment

Next, the second embodiment of this disclosure will be described. In the second embodiment, the door restricting portion 151 of the first embodiment is configured to be disposed on a member separate from the drive rack 15. Therefore, with respect to configurations similar to those in the first embodiment, illustrations are omitted or the same reference characters are employed in drawings for description.

### Opening Restriction Mechanism of Door

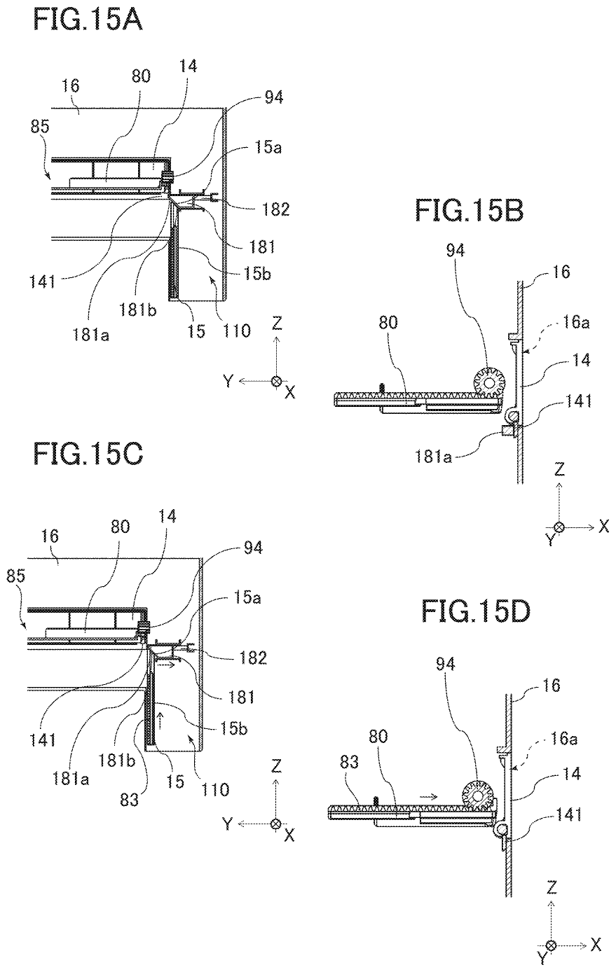

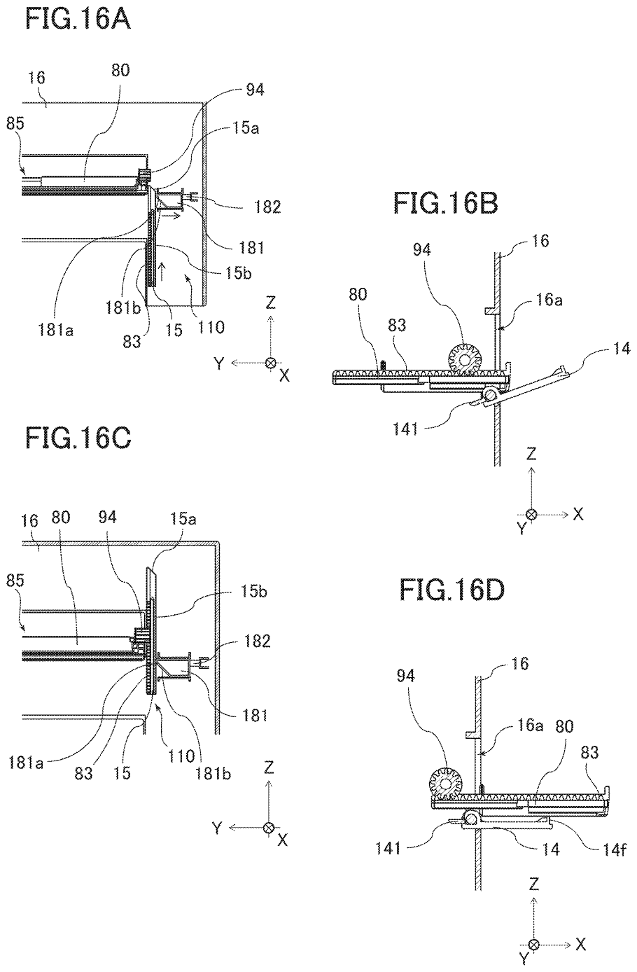

Using FIGS. 15A to 16D, a mechanism for restricting the movement of the door 14 from the closed position to the open position according to the second embodiment will be described. FIG. 15A is a rear view illustrating a door restriction member 181 positioned in the restricting position, and FIG. 15B is a cross-sectional view illustrating the door 14 positioned in the closed position and the tray 80 positioned in the accommodating position. FIG. 15C is a rear view illustrating a state in which the door restriction member 181 is pressed by the drive rack 15 that moves upward, and FIG. 15D is a cross-sectional view illustrating a state in which the drive rack 15 moves upward from the non-engagement position. FIG. 16A is a rear view illustrating a state in which the drive rack 15 moves further upward, and FIG. 16B is a cross-sectional view illustrating a state in which the door 14 is pressed toward the open position by the tray 80. FIG. 16C is a rear view illustrating the door restriction member 181 positioned in a retracted position, and FIG. 16D is a cross-sectional view illustrating the tray 80 positioned in the take-out position and the door 14 positioned in the open position. To be noted, in FIGS. 15A to 16D, the toner cartridge 70 supported by the tray 80 and the spring 14s for urging the door 14 are not illustrated.

As illustrated in FIGS. 15A and 15B, in the case where the image forming apparatus 1 is performing the image formation or is in the standby state, the tray 80 is positioned in the accommodating position in which the tray 80 is accommodated in the rotary body 90. At this time, the door 14 is positioned in the closed position in which the door 14 closes the opening 16a by the urging force of the spring 14s. The transmission device 110 of this embodiment (refer to FIGS. 11A and 11B) includes the door restriction member 181, serving as a restricting member that is configured separately from the drive rack 15 and is disposed adjacent to the drive rack 15. The door restriction member 181 may be disposed in two, corresponding to the left and right drive racks 15L and 15R, or may be disposed in only one, corresponding to either one of the left and right drive racks 15L and 15R.

The door restriction member 181 is configured to slidably move in the Y-axis direction, is urged in the Y direction by an urging member 182, and is positioned in the restricting position in which the door restriction member 181 comes into contact with the drive rack 15 positioned in the non-engagement position. The door restriction member 181 includes a door restricting portion 181a disposed at a distal end of the door restriction member 181 in the Y direction, and an inclined surface 181b that extends toward a downstream side in the Z direction when extending toward a downstream side in the Y direction. The door restriction member 181 is an example of the movement restricting portion.

In a state in which the drive rack 15 is positioned in the non-engagement position, the tray 80 is positioned in the accommodating position, and the door 14 is positioned in the closed position, the door restricting portion 181a of the door restriction member 181, which is positioned in the restricting position, is disposed to come into contact with the restricted portion 141 of the door 14 in the X direction. In addition, the door restricting portion 181a of the door restriction member 181 is disposed to overlap with the moving trajectory when the door 14 moves from the closed position to the open position. In other words, the door restriction member 181 is in the restricting state that restricts the door 14 from moving from the closed position to the open position.

That is, the door restricting portion 181a of the door restriction member 181 positioned in the restricting state is disposed to overlap with the moving trajectory of the restricted portion 141 when the door 14 moves from the closed position to the open position. In other words, the door restricting portion 181a of the door restriction member 181 located in the restricting state is positioned inside the moving trajectory of the restricted portion 141 when the door 14 moves from the closed position to the open position.

Therefore, even if the user attempts to open the door 14 from the closed position toward the open position, the restricted portion 141 of the door 14 abuts against the door restricting portion 181a; thereby, the movement of the door 14 from the closed position to the open position is restricted. That is, in the case where the image forming apparatus 1 is performing the image formation or is in the standby state, it is possible to prevent the user from inadvertently opening the door 14.

As illustrated in FIGS. 15C and 15D, when replacing the toner cartridge 70 (not shown) supported by the tray 80, the motor M2 (refer to FIG. 2) is driven. Then, the driving force of the motor M2 is transmitted to the drive rack 15 by the transmission portion 15t, and the drive rack 15 moves upward in the Z direction. A pressing inclined surface 15a is formed at a downstream end of the drive rack 15 in the Z direction, and when the drive rack 15 moves upward in the Z direction, the pressing inclined surface 15a presses the inclined surface 181b of the door restriction member 181. Thereby, the door restriction member 181 slidably moves in the −Y direction toward the retracted position illustrated in FIG. 16C. In other words, the door restriction member 181 is configured to move in conjunction with the drive rack 15 by being pressed by the drive rack 15. Then, the door restricting portion 181a of the door restriction member 181 no longer opposes the restricted portion 141 of the door 14 in the X direction, and separates from the restricted portion 141. In other words, the door restricting portion 181a moves to a position in which the door restricting portion 181a does not overlap with the restricted portion 141 of the door 14 when viewed in the X direction. Thereby, the door restricting portion 181a transitions to the permitting state that permits the door 14 to move from the closed position to the open position, and the door 14 becomes movable from the closed position toward the open position.

That is, the door restricting portion 181a of the door restriction member 181 located in the permitting state is disposed so as not to overlap with the moving trajectory of the restricted portion 141 when the door 14 moves from the closed position to the open position. In other words, the door restricting portion 181a of the door restriction member 181 located in the permitting state is positioned outside the moving trajectory of the restricted portion 141 when the door 14 moves from the closed position to the open position.

At this time, the drive rack 15 is not yet engaged with the pinion gear 94, and the tray 80 has not moved from the accommodating position. Therefore, the tray 80 is not in contact with the door 14. That is, before the tray 80 moves from the accommodating position to the take-out position, the door restriction member 181 transitions from the restricting state to the permitting state. In other words, before the toner cartridge 70 supported by the tray 80 moves from the attachment position to the retracted position, the door restriction member 181 transitions from the restricting state to the permitting state.

Also in this embodiment, the drive rack (rack gear) 15 is an example of the first gear and gear driven by the motor M2. In addition, the pinion gear 94 is an example of the second gear driven by the drive rack 15. The door restriction member 181 transitions from the restricting state to the permitting state before the drive rack 15 moves from the separation position to the engagement position. That is, the door restriction member 181, including the door restricting portion 181a, transitions from the restricting state to the permitting state before the engagement between the drive rack 15 and the pinion gear 94 is initiated.

As illustrated in FIGS. 16A and 16B, when the drive rack 15 moves further upward in the Z direction, the pinion gear 94 is rotated by the drive rack 15. Since the rack portion 83 of the tray 80 is in engagement with the pinion gear 94, the rotation of the pinion gear 94 causes the tray 80 to move in the X direction from the accommodating position toward the take-out position. By being pressed by the tray 80, the door 14 pivots from the closed position toward the open position while resisting the urging force of the spring 14s.

In addition, after the door restriction member 181 moves in the-Y direction from the restricting position (the position illustrated in FIG. 15A), the door restricting portion 181a of the door restriction member 181 comes into contact with a contact surface 15b, which is an end face of the drive rack 15 in the −Y direction. Due to the door restriction member 181 being urged in the Y direction by the urging member 182, the door restricting portion 181a continues to remain in contact with the contact surface 15b even when the drive rack 15 moves further upward from the position illustrated in FIG. 16A.

As illustrated in FIGS. 16C and 16D, in the state in which the tray 80 is positioned in the take-out position, the door 14 is positioned in the open position. At this time, the support portion 14f of the door 14 supports the tray 80 positioned in the take-out position from below. Thereby, since the tray 80 is stably held in the take-out position, workability can be improved when detaching the toner cartridge 70 (not shown) supported by the tray 80 from the tray 80.

When the tray 80 moves from the take-out position to the accommodating position after the toner cartridge 70 has been replaced, the drive rack 15 moves downward in the −Z direction, and returns to the non-engagement position. Therefore, by the urging force of the urging member 182, the door restriction member 181 causes the door restricting portion 181a to again come into contact with the restricted portion 141 of the door 14 as illustrated in FIGS. 15A and 15B; thereby, the door restriction member 181 transitions to the restricting state.

As described above, in this embodiment, the door restriction member 181 transitions from the restricting state to the permitting state by being pressed by the drive rack 15 that constitutes a part of the transmission device 110 (refer to FIGS. 11A and 11B). That is, the door restriction member 181, including the door restricting portion 181a, transitions from the restricting state to the permitting state by the driving force of the motor M2. When the toner cartridge 70 is positioned in the attachment position, the door restriction member 181 is in the restricting state that restricts the movement of the door 14 from the closed position to the open position. Therefore, in the case where the image forming apparatus 1 is performing the image formation or is in the standby state, it is possible to prevent the user from inadvertently opening the door 14.

In addition, in the moving operation of the moving device 85, before the toner cartridge 70 moves from the attachment position to the retracted position, the door restriction member 181 transitions from the restricting state to the permitting state. Therefore, when the tray 80 supporting the toner cartridge 70 presses the door 14 due to the moving operation of the moving device 85, the door restriction member 181 is in the permitting state, and the movement of the door 14 to the open position is not obstructed. Therefore, damage to the door 14 and the tray 80 can be suppressed.

### Other Embodiments

In addition, in the first embodiment, the drive rack 15 is provided with the door restricting portion 151, and, in the second embodiment, the door restricting portion 181a is provided in the door restriction member 181 that moves in conjunction with the drive rack 15; however, it is not limited to this. For example, it is acceptable if the door restriction member that restricts the opening operation of the door 14 is configured to be moved by the driving force of the motor M2. In addition, the configuration of the transmission device 110 is also not limited to the first and second embodiments described above, and the configuration may be arbitrarily modified.

In addition, in any of embodiments described above, the image forming apparatus 1 includes the rotary body 90, and is configured such that the toner cartridge 70 is detachably attached to the rotary body 90; however, it is not limited to this. For example, the image forming apparatus 1 may be a monochrome printer or a tandem-type full-color printer instead of the rotary-type printer. In these printers, the toner cartridge 70 may be configured to be detachably attached to a developing cartridge or a process cartridge.

In addition, the configuration of the transmission device 110 for moving the tray 80 is not limited to the so-called rack and pinion configuration. For example, a member corresponding to the pinion gear 94 may be replaced with a roller that rotates by being driven by the motor M2, and the tray 80 may be moved by friction between the roller and the tray 80.

In addition, in a case of employing a roller that rotates by receiving the drive of the motor M2, the roller may be brought into contact with toner cartridge 70. In this case, the toner cartridges 70y to 70k can be configured to be directly attached to and detached from the rotary body 90 without the intermediary of the trays 80y to 80k. In this case, the moving device 85 is constituted by the roller. Further, the rotary assembly 90A can be said to include the rotary body 90 and the toner cartridges 70y to 70k.

In addition, each of embodiments described above may be combined in whole or in part, respectively.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-068391, filed Apr. 17, 2025, which is hereby incorporated by reference herein in its entirety.

What is claimed is:

1. An image forming apparatus to which a toner cartridge provided with a discharge opening is detachably attached, the image forming apparatus comprising:
a rotary configured to rotate, the rotary including:
a developing roller; and
an accommodating frame provided with an accommodating portion and a receiving opening, the accommodating portion being configured to accommodate toner to be supplied to the developing roller, the receiving opening being configured to communicate with the accommodating portion;
a main body frame configured to accommodate the rotary and provided with a main body opening;
an opening/closing member openably and closably supported with respect to the main body frame between a closed position in which the opening/closing member closes the main body opening and an open position in which the opening/closing member opens the main body opening;
a moving device configured to execute a moving operation of moving the toner cartridge from an attachment position to a retracted position through the main body opening;
a drive source configured to cause the moving device to execute the moving operation; and
a movement restricting portion configured to transition between a restricting state in which movement of the opening/closing member from the closed position to the open position is restricted, and a permitting state in which the movement of the opening/closing member from the closed position to the open position is permitted,
wherein, in a case where the toner cartridge is in the attachment position, the receiving opening and the discharge opening face each other,
wherein, at least a portion of the toner cartridge is positioned outside the main body frame in a case where the toner cartridge is in the retracted position, and
wherein the movement restricting portion is in the restricting state when the toner cartridge is positioned in the attachment position, and is configured to transition from the restricting state to the permitting state by a driving force of the drive source before the moving device moves the toner cartridge from the attachment position to the retracted position during the moving operation.

2. The image forming apparatus according to claim 1, further comprising a transmission unit including:
a first gear configured to be driven by the drive source; and
a second gear configured to be driven by the first gear,
wherein the transmission unit is configured to transmit the driving force of the drive source to the moving device,
wherein the first gear is configured to move to an engagement position in which the first gear engages with the second gear, and to a separation position in which the first gear is separated from the second gear, and
wherein the movement restricting portion is configured to transition from the restricting state to the permitting state before the first gear moves from the separation position to the engagement position during the moving operation of the moving device.

3. The image forming apparatus according to claim 2, wherein the rotary is configured to support the second gear.

4. The image forming apparatus according to claim 1, wherein the moving device includes a support member configured to be attached to the rotary, the support member being configured to detachably support the toner cartridge,
wherein the support member is configured to move to an accommodating position in which the toner cartridge is positioned in the attachment position, and to a take-out position in which the toner cartridge is positioned in the retracted position,
wherein the toner cartridge is configured to be detached from the support member when the support member is positioned in the take-out position, and
wherein the drive source is configured to move the support member.

5. The image forming apparatus according to claim 4, wherein the opening/closing member is configured to move from the closed position to the open position by being pressed by the support member supporting the toner cartridge which moves from the attachment position to the retracted position.

6. The image forming apparatus according to claim 4, wherein the opening/closing member is configured to support the support member positioned in the take-out position when the opening/closing member is in the open position.

7. The image forming apparatus according to claim 4, further comprising a transmission unit that includes a gear configured to be driven by the drive source, the transmission unit being configured to transmit the driving force of the drive source to the support member,
wherein the movement restricting portion is configured to move in conjunction with the gear.

8. The image forming apparatus according to claim 7, wherein the movement restricting portion is formed integrally with the gear.

9. The image forming apparatus according to claim 7, wherein the movement restricting portion is formed separately from the gear, and is configured to move in conjunction with the gear when being pressed by the gear.

10. The image forming apparatus according to claim 7, wherein the gear is a rack member configured to move slidably.

11. The image forming apparatus according to claim 1, further comprising a photosensitive drum,
wherein the rotary is configured to rotate to a developing posture in which the developing roller faces the photosensitive drum and to a replacement posture in which detachment of the toner cartridge from the rotary is allowed.

12. An image forming apparatus to which a cartridge is detachably attached, the image forming apparatus comprising:
a main body frame provided with a main body opening;
an opening/closing member openably and closably supported with respect to the main body frame between a closed position in which the opening/closing member closes the main body opening and an open position in which the opening/closing member opens the main body opening;
a moving device configured to execute a moving operation of moving the cartridge from an attachment position to a retracted position through the main body opening;
a drive source configured to cause the moving device to execute the moving operation; and
a movement restricting portion configured to transition between a restricting state in which movement of the opening/closing member from the closed position to the open position is restricted, and a permitting state in which the movement of the opening/closing member from the closed position to the open position is permitted,
wherein the cartridge is accommodated in the main body frame in a case where the cartridge is in the attachment position,
wherein at least a portion of the cartridge is positioned outside the main body frame in a case where the cartridge is in the retracted position, and
wherein the movement restricting portion is in the restricting state when the cartridge is positioned in the attachment position, and is configured to transition from the restricting state to the permitting state by a driving force of the drive source before the moving device moves the cartridge from the attachment position to the retracted position during the moving operation.

13. The image forming apparatus according to claim 12, wherein the moving device includes a support member configured to detachably support the cartridge,
wherein the support member is configured to move to an accommodating position in which the cartridge is positioned in the attachment position, and to a take-out position in which the cartridge is positioned in the retracted position,
wherein the cartridge is configured to be detached from the support member when the support member is in the take-out position, and
wherein the drive source is configured to move the support member.

14. The image forming apparatus according to claim 13, wherein the opening/closing member is configured to move from the closed position to the open position by being pressed by the support member supporting the cartridge which moves from the attachment position to the retracted position.

15. The image forming apparatus according to claim 13, wherein the opening/closing member is configured to support the support member positioned in the take-out position when the opening/closing member is in the open position.

16. The image forming apparatus according to claim 13, further comprising a transmission unit that includes a gear configured to be driven by the drive source, the transmission unit being configured to transmit the driving force of the drive source to the support member,
wherein the movement restricting portion is configured to move in conjunction with the gear.

17. The image forming apparatus according to claim 16, wherein the movement restricting portion is formed integrally with the gear.

18. The image forming apparatus according to claim 16, wherein the movement restricting portion is formed separately from the gear, and is configured to move in conjunction with the gear when being pressed by the gear.

19. The image forming apparatus according to claim 16, wherein the gear is a rack member configured to move slidably.
